(19) United States
(12) Patent Application Publication
(10) Pub. No.: US 2007/0270987 A1
(43) Pub. Date: Nov. 22, 2007

(54) Signal processing method, signal processing apparatus and recording medium

(75) Inventor: Osamu Fujii, Yaita-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/702,649

(22) Filed: Feb. 6, 2007

(30) Foreign Application Priority Data
May 18, 2006 (JP) 2006-139400
May 18, 2006 (JP) 2006-139401
May 18, 2006 (JP) 2006-139402

(51) Int. Cl. G06F 17/00

(52) U.S. Cl. 700/94

(57) ABSTRACT

The minimum value detecting circuit detects a minimum value, excluding zero, of a coefficient according to a dequantized acoustic signal. The correction coefficient computing circuit computes a correction coefficient based on the minimum value and white noise outputted from the white noise storage which stores white noise. In this process, a correction coefficient is computed by, for example, dividing the minimum value obtained by the minimum value detecting circuit by a value which is twice the maximum value or the mean value of white noise stored in the white noise storage. The correction value computing circuit computes a correction value by multiplying the correction coefficient computed by the correction coefficient computing circuit by white noise stored in the white noise storage. A corrected coefficient is computed by adding the correction value obtained as described above to a frequency band having a null coefficient according to a dequantized acoustic signal.

### CROSS-REFERENCE OF RELATED APPLICATION

This Nonprovisional Application claims priority under 35 U.S.C.§119(a) on Patent Application No. 2006-139400 in Japan on May 18, 2006, Patent Application No. 2006-139401 in Japan on May 18, 2006, and Patent Application No. 2006-139402 in Japan on May 18, 2006, the entire contents of which are hereby incorporated by reference.

### BACKGROUND OF THE INVENTION

1. Field of the Invention

The present invention relates to a signal processing method and a signal processing apparatus for processing an acoustic signal obtained by dequantizing a coded acoustic signal and a computer-readable recording medium which records therein a program for causing the signal processing apparatus to function as a computer.

2. Description of the Prior Art

Known as a technique for coding an acoustic signal is MP3 (MPEG 1 Audio Layer 3), AAC (Advanced Audio Coding), ATRAC (Adaptive TRansform Acoustic Coding), WMA (Windows (registered trademark) Media Audio), AC-3 (Audio Code Number 3) and the like. In the MP3 method, for example, an acoustic signal is divided into a plurality of frequency bands and blocked in a unit of varying-length time in order to achieve high efficient compression. The blocked digital data is transformed into a spectrum signal by the MDCT (Modified Discrete Cosine Transform) process. Each spectrum signal of the transformed digital data is coded by bits which are allocated using the auditory psychology characteristic (see Patent Documents 1 to 3, for example).

An acoustic signal coded as described above is decoded by a decoding apparatus. FIG. 1 is a block diagram showing the hardware structure of a conventional decoding apparatus. Denoted at 100 in the figure is a conventional decoding apparatus which comprises an unpacking circuit 101, a dequantizing circuit 102, a frequency-time transforming circuit 103, a frequency band synthesizing circuit 104 and an acoustic signal output unit 105. A coded acoustic signal is inputted into the unpacking circuit 101, and the quantization coefficient, the scale factor, the scale factor multiplexer, the global gain and the subblock gain are respectively unpacked from frame information of the acoustic signal. The acoustic signal is then dequantized into an IMDCT (Inverse Modified Discrete Cosine Transform) coefficient by the dequantizing circuit 102 using the quantization coefficient, the scale factor, the scale factor multiplexer, the global gain and the subblock gain.

The IMDCT coefficient obtained by dequantization by the dequantizing circuit 102 undergoes an IMDCT process at the frequency-time transforming circuit 103 for each frequency band and transformed into data in relation to time axis. The inverted frequency band further undergoes band synthesis by an IPFB (Inverse Polyphase Filter Bank), which is a band synthesizing filter, at the frequency band synthesizing circuit 104 and then outputted to the acoustic signal output unit 105 (see Patent Document 3, for example).

Moreover, a technique has been disclosed for complementing a spectrum at the time of decoding with a spectrum for power adjustment in order to compensate for the lack of sense of power caused by compression (see Patent Document 4, for example). In the technique described in Patent Document 4, power adjustment information to be used for complement is generated at a power adjustment information deciding circuit in a coding apparatus based on the characteristic of an input audio signal at the time of coding. Next, the power adjustment information is coded together with the coded audio signal. The coded power adjustment information is then decoded at a power adjustment information decoding circuit in a decoding apparatus and power adjustment information is further generated at a power correction spectrum generating and synthesizing circuit so as to complement the decoded audio signal with the power adjustment information.

[Patent Document 1]

Japanese Patent Application Laid-Open No. 2002-351500

[Patent Document 2]

Japanese Patent Application Laid-Open No. 2005-195983

[Patent Document 3]

Japanese Patent Application Laid-Open No. 2005-26940

[Patent Document 4]

Japanese Patent Application Laid-Open No. 2003-323198

However, in the technique wherein an acoustic signal or an image signal is quantized in the process of coding, there is a problem that rounding or round-down by dequantization may cause energy loss of the acoustic signal or the image signal. Therefore, the user may feel dissatisfaction at the acoustic signal or the image signal due to the energy loss even at the time of decoding. Patent Documents 1 to 3 do not offer means for solving such a problem. Moreover, as the technique described in Patent Document 4 is designed to complement power, it is necessary to analyze an input audio signal by a coding apparatus at the time of coding and generate power adjustment information so as to code the signal. Furthermore, it is also necessary to provide a power adjustment information decoding circuit in a decoding apparatus and decode the coded power adjustment information, and there is a problem that interpolation of energy cannot be performed at all for an acoustic signal for which such power adjustment information is not stored. Especially, since coding methods associated with various specifications are made indiscriminately in recent years, there is a problem that the technique described in Patent Document 4 cannot suitably interpolate a coded acoustic signal or a coded image signal of various methods.

### BRIEF SUMMARY OF THE INVENTION

The present invention has been made with the aim of solving the above problems. An object of the present invention is to provide: a signal processing method and a signal processing apparatus for computing a correction coefficient based on white noise outputted from a white noise storage and a level of a coefficient of a dequantized acoustic signal, computing a correction value by multiplying the white noise by the correction coefficient and adding the correction value to a coefficient so as to interpolate energy lost at the time of coding, eliminate dissatisfaction associated with energy shortage and deal with various coding methods in decoding; and a computer-readable recording medium which records therein a program for causing a computer to function as the signal processing apparatus.

Another object of the present invention is to provide a signal processing apparatus for dividing the level of a coefficient by a level of white noise stored in the white noise storage so as to compute the most suitable correction coefficient.

Another object of the present invention is to provide a signal processing apparatus for computing an energy change rate and a level change rate and correcting a level when the energy change rate is smaller than the level change rate, so as to reduce fluctuation in the correction value to be used for addition.

Another object of the present invention is to provide a signal processing apparatus for correcting a level so that the energy change rate and the level change rate become approximately equal when the energy change rate is smaller than the level change rate, so as to further reduce fluctuation in the correction value to be used for addition.

Another object of the present invention is to provide a signal processing apparatus for computing a correction coefficient based on a level and white noise and setting said level to a level when the energy change rate is larger than the level change rate, so as to compute the most suitable correction value depending on an energy change.

Another object of the present invention is to provide: a signal processing method and a signal processing apparatus for computing a corrected coefficient by adding a value relating to white noise to a coefficient of a dequantized acoustic signal when it is not determined that the acoustic signal is a pure tone, so as to deal with various coding methods in decoding and suitably interpolate energy; and a computer-readable recording medium which records therein a program for causing a computer to function as the signal processing apparatus.

Another object of the present invention is to provide a signal processing method and the like for determining whether a bit rate of an acoustic signal is smaller than a prestored reference bit rate or not and computing a corrected coefficient by adding a value relating to white noise to a coefficient of the acoustic signal when it is determined that the bit rate of the acoustic signal is smaller than the reference bit rate, so as to deal with various coding methods in decoding and suitably interpolate energy.

Another object of the present invention is to provide a signal processing apparatus for reading out a reference bit rate corresponding to a sampling frequency of an acoustic signal from a table, determining whether a bit rate of an acoustic signal is smaller than the read-out reference bit rate or not and correcting a coefficient when the bit rate of the acoustic is smaller, so as to execute suitable energy interpolation even when an acoustic signal according to a different sampling frequency is inputted.

Another object of the present invention is to provide: a signal processing method and a signal processing apparatus for determining whether there is a null orthogonal transform coefficient in a coded acoustic signal or a coded image signal which has been dequantized and adding an orthogonal transform coefficient according to a white noise source to a frequency band when it is determined that there is a null orthogonal transform coefficient, so as to interpolate energy lost at the time of coding and eliminate dissatisfaction associated with energy shortage; and a computer-readable recording medium which records therein a program for causing the signal processing apparatus to function as a computer.

A signal processing method according to the present invention for processing an acoustic signal obtained by dequantizing a coded acoustic signal comprises: a level detecting step of detecting a level of a coefficient of a dequantized acoustic signal; a correction coefficient computing step of computing a correction coefficient based on the level and white noise outputted from a white noise storage which stores white noise; a correction value computing step of computing a correction value by multiplying white noise stored in the white noise storage by the correction coefficient; and a correction frequency coefficient computing step of computing a corrected coefficient by adding the correction value to a coefficient of a dequantized acoustic signal.

A signal processing apparatus according to the present invention for processing an acoustic signal obtained by dequantizing a coded acoustic signal comprises: a level detecting circuit for detecting a level of a coefficient of a dequantized acoustic signal; a correction coefficient computing circuit for computing a correction coefficient based on the level and white noise outputted from a white noise storage which stores white noise; a correction value computing circuit for computing a correction value by multiplying white noise stored in the white noise storage by the correction coefficient; and a correction frequency coefficient computing circuit for computing a corrected coefficient by adding the correction value to a coefficient of a dequantized acoustic signal.

The level detecting circuit according to the present invention is constructed to detect a minimum value, excluding zero, of a coefficient of the quantized acoustic signal.

The correction coefficient computing circuit according to the present invention is constructed to compute a correction coefficient by dividing a level detected by the level detecting circuit by a level of white noise stored in the white noise storage.

The level of the white noise according to the present invention is a maximum value or a mean value of white noise stored in the white noise storage.

The signal processing apparatus according to the present invention further comprises: an energy computing circuit for computing energy or a mean power spectrum based on a coefficient of a dequantized acoustic signal; an energy change rate computing circuit for computing a rate of change between energy or a mean power spectrum of a unit of decoding processing at a predetermined time computed by the energy computing circuit and energy or a mean power spectrum of a unit of decoding processing before the predetermined time; a level change rate computing circuit for computing a rate of change between a level of a unit of decoding processing at a predetermined time detected by the level detecting circuit and a level of a unit of decoding processing before the predetermined time; a determining circuit for determining whether the energy change rate is larger than the level change rate or not; a level correcting circuit for correcting a level to be used by the correction coefficient computing circuit when it is determined by the determining circuit that the energy change rate is smaller than the level change rate; and a correction level setting circuit for setting a level corrected by the level correcting circuit to a level to be used by the level change rate computing circuit.

The level correcting circuit according to the present invention is constructed to correct a level to be used by the correction coefficient computing circuit so that the rate of change of the energy or the mean power spectrum and the level change rate become approximately equal.

The correction coefficient computing circuit according to the present invention is constructed to compute a correction coefficient based on white noise and a level detected by the level detecting circuit when it is determined by the determining circuit that the energy change rate is larger than the level change rate.

The signal processing apparatus according to the present invention further comprises a level setting circuit for setting a level detected by the level detecting circuit to a level to be used by the level change rate computing circuit when it is determined by the determining circuit that the energy change rate is larger than the level change rate.

A computer-readable recording medium according to the present invention, which records therein a program for causing a computer to process an acoustic signal obtained by dequantizing a coded acoustic signal, comprises: a level detecting step of detecting a level, excluding zero, of a coefficient of a dequantized acoustic signal; a correction coefficient computing step of computing a correction coefficient based on the level and white noise outputted from a white noise storage which stores white noise; a correction value computing step of computing a correction value by multiplying white noise stored in the white noise storage by the correction coefficient; and a correction frequency coefficient computing step of computing a corrected coefficient by adding the correction value to a coefficient of a dequantized acoustic signal.

In the present invention, the level detecting circuit detects a level of a coefficient according to an acoustic signal obtained by dequantizing a coded acoustic signal. The correction coefficient computing circuit computes a correction coefficient based on the level and white noise outputted from a white noise storage which stores white noise. In this process, the correction coefficient is computed by, for example, dividing a minimum value, excluding zero, of a coefficient by a level (e.g., a maximum value or a mean value) of white noise stored in the white noise storage. The correction value computing circuit computes a correction value by multiplying the correction coefficient computed by the correction coefficient computing circuit by white noise stored in the white noise storage. The present invention is constructed to compute a corrected coefficient by adding the correction value obtained as described above to each coefficient. Accordingly, a correction value according to white noise of the most suitable amount can be added depending on a level of a coefficient existing in a band. As a result, energy lost at the time of quantization is interpolated by the most suitable amount.

In the present invention, the energy computing circuit computes energy or a mean power spectrum based on a coefficient according to a dequantized acoustic signal. Then, the energy change rate computing circuit computes a rate of change between energy or a mean power spectrum of a unit of decoding processing at a predetermined time computed by the energy computing circuit and energy or a mean power spectrum of a unit of decoding processing before the predetermined time. Similarly, the level change rate computing circuit computes a rate of change between a level of a unit of decoding processing at a predetermined time detected by the level detecting circuit and a level of a unit of decoding processing before the predetermined time. The determining circuit determines whether the obtained energy change rate is larger than the level change rate or not.

The level correcting circuit corrects a level to be used by the correction coefficient computing circuit when it is determined by the determining circuit that the energy change rate is smaller than the level change rate. Here, the level is corrected so that the energy change rate and the level change rate become approximately equal, for example. Then, the correction level setting circuit sets a level corrected by the level correcting circuit to a level at a time to be used by the level change rate computing circuit. Since the level is corrected depending on the energy change rate and the level change rate as described above, the correction value to be added to the coefficient is kept from drastic fluctuation.

In the present invention, the correction coefficient computing circuit computes a correction coefficient based on white noise and a level detected by the level detecting circuit when the energy change rate is larger than the level change rate. Moreover, the level setting circuit sets a level detected by the level detecting circuit to a level at a time to be used by the level change rate computing circuit. That is, the correction value is computed based on the correction value and white noise without correcting the level detected by the level detecting circuit when the energy change rate is larger than the level change rate. Since the present invention is constructed to arbitrarily correct the correction value depending on relation between the energy change rate and the level change rate, it becomes possible to prevent occurrence of drastic fluctuation of the correction amount.

A signal processing method according to the present invention for processing an acoustic signal obtained by dequantizing a coded acoustic signal comprises: an index value computing step of computing a tonality index value indicative of a degree of tonality of a dequantized acoustic signal; a tonality judging step of determining whether the acoustic signal is a pure tone or not by comparing the tonality index value computed in the index value computing step with a prestored reference value; an output step of outputting white noise from a white noise storage which stores white noise; and a correction frequency coefficient computing step of computing a corrected coefficient by adding a value relating to white noise outputted in the output step to each coefficient of the acoustic signal.

A signal processing method according to the present invention for processing an acoustic signal obtained by dequantizing a coded acoustic signal comprises: a bit rate comparing step of determining whether a bit rate of an acoustic signal is smaller than a prestored reference bit rate or not; an output step of outputting white noise from a white noise storage which stores white noise; and a correction frequency coefficient computing step of computing a corrected coefficient by adding a value relating to white noise outputted in the output step to each coefficient of the acoustic signal when it is determined in the bit rate comparing step that the bit rate of the acoustic signal is smaller than the reference bit rate.

A signal processing apparatus according to the present invention for processing an acoustic signal obtained by dequantizing a coded acoustic signal comprises: an index value computing circuit for computing a tonality index value indicative of a degree of tonality of a dequantized acoustic signal; a tonality judging circuit for determining whether the acoustic signal is a pure tone or not by comparing the tonality index value computed by the index value computing circuit with a prestored reference value; an output unit for outputting white noise from a white noise storage which stores white noise; and a correction frequency coefficient computing circuit for computing a corrected coefficient by adding a value relating to the white noise outputted from the output unit to each coefficient of the acoustic signal.

The index value computing circuit according to the present invention is constructed to make a value, which is obtained by subtracting a mean value from a maximum value of a value relating to a scale factor of each frequency band, a tonality index value.

A signal processing apparatus according to the present invention for processing an acoustic signal obtained by dequantizing a coded acoustic signal comprises: a bit rate comparing circuit for determining whether a bit rate of an acoustic signal is smaller than a prestored reference bit rate or not; an output unit for outputting white noise from a white noise storage which stores white noise; and a correction frequency coefficient computing circuit for computing a corrected coefficient by adding a value relating to the white noise outputted from the output unit to each coefficient of the acoustic signal when it is determined by the bit rate comparing circuit that the bit rate of the acoustic signal is smaller than the reference bit rate.

The signal processing apparatus according to the present invention further comprises a table which stores a reference bit rate to be a reference for each sampling frequency, wherein the bit rate comparing circuit is constructed to read out a reference bit rate corresponding to a sampling frequency of an acoustic signal from the table and determine whether the bit rate of the acoustic signal is smaller than the read-out reference bit rate or not, and the correction frequency coefficient computing circuit is constructed to compute a corrected coefficient by adding a value relating to the white noise outputted from the output unit to a coefficient of each frequency band of the acoustic signal when it is determined by the bit rate comparing circuit that the bit rate of the acoustic signal is smaller than the reference bit rate.

The signal processing apparatus according to the present invention further comprises: a level detecting circuit for detecting a level of a coefficient of a dequantized acoustic signal; a correction coefficient computing circuit for computing a correction coefficient based on the level and white noise outputted from the white noise storage; and a correction value computing circuit for computing a correction value by multiplying white noise stored in the white noise storage by the correction coefficient, wherein the correction frequency coefficient computing circuit is constructed to compute a corrected coefficient by adding the correction value, as a value relating to white noise, to a coefficient of a dequantized acoustic signal.

The level detecting circuit according to the present invention is constructed to detect a minimum value, excluding zero, of a coefficient of the dequantized acoustic signal.

The correction coefficient computing circuit according to the present invention is constructed to compute a correction coefficient by dividing a level detected by the level detecting circuit by a level of white noise stored in the white noise storage.

The level of the white noise according to the present invention is a maximum value or a mean value of white noise stored in the white noise storage.

A computer-readable recording medium which records therein a program for causing a computer to process an acoustic signal obtained by dequantizing a coded acoustic signal comprises: an index value computing step of computing a tonality index value indicative of a degree of tonality of a dequantized acoustic signal; a tonality judging step of determining whether the acoustic signal is a pure tone or not by comparing the tonality index value computed in the index value computing step with a prestored reference value; an output step of outputting white noise from a white noise storage which stores white noise; and a correction frequency coefficient computing step of computing a corrected coefficient by adding a value relating to white noise outputted in the output step to each coefficient of the acoustic signal.

A computer-readable recording medium which records therein a program for causing a computer to process an acoustic signal obtained by dequantizing a coded acoustic signal comprises: a bit rate comparing step of determining whether a bit rate of an acoustic signal is smaller than a prestored reference bit rate or not; an output step of outputting white noise from a white noise storage which stores white noise; and a correction frequency coefficient computing step of computing a corrected coefficient by adding a value relating to white noise outputted in the output step to each coefficient of the acoustic signal when it is determined in the bit rate comparing step that the bit rate of the acoustic signal is smaller than the reference bit rate.

In the present invention, the index value computing circuit computes a tonality index value indicative of the degree of tonality of a dequantized acoustic signal. The tonality index value is obtained by, for example, subtracting a mean value from a maximum value of a value relating to a scale factor of each frequency band. The output unit outputs white noise from the white noise storage which stores white noise. The tonality judging circuit determines whether the acoustic signal is a pure tone or not by comparing the tonality index value computed by the index value computing circuit with a prestored reference value. Then, the correction frequency coefficient computing circuit computes a corrected coefficient by adding a value relating to white noise, which is computed based on white noise outputted from the white noise storage, to a coefficient of an acoustic signal when it is not determined by the tonality judging circuit that the acoustic signal is a pure tone. Accordingly, it becomes possible to determine whether energy is to be interpolated or not independently in decoding and suitably interpolate energy for various specifications.

In the present invention, the bit rate comparing circuit determines whether a bit rate of an acoustic signal is smaller than a prestored reference bit rate or not. The correction frequency coefficient computing circuit is constructed to compute a corrected coefficient by adding a value relating to white noise outputted from a white noise storage to a coefficient when it is determined by the bit rate comparing circuit that the bit rate of the acoustic signal is smaller than the reference bit rate. Accordingly, it becomes possible to determine whether energy is to be interpolated or not independently in decoding and suitably interpolate energy for various specifications.

In the present invention, a reference bit rate which becomes a reference for each sampling frequency is stored in the table. The bit rate comparing circuit reads out a reference bit rate corresponding to a sampling frequency of an acoustic signal from the table and determines whether the bit rate of the acoustic signal is smaller than the read-out reference bit rate or not. Then, the correction frequency coefficient computing circuit computes a corrected coefficient by adding a value relating to white noise outputted from the white noise storage to a coefficient of the acoustic signal when it is determined by the bit rate comparing circuit that the bit rate of the acoustic signal is smaller than the reference bit rate. As described above, it becomes possible to provide a reference bit rate for each sapling frequency, add white noise depending on the sampling frequency and the reference bit rate, and suitably interpolate various acoustic signals of different kinds.

In the present invention, the level detecting circuit detects a level of a coefficient of an acoustic signal obtained by dequantizing a coded acoustic signal. The correction coefficient computing circuit computes a correction coefficient based on the level and white noise outputted from the white noise storage which stores white noise. In this process, the correction coefficient is computed by, for example, dividing a minimum value, excluding zero, of a coefficient by a level (e.g., a maximum value or a mean value) of white noise stored in the white noise storage. The correction value computing circuit computes a correction value by multiplying the correction coefficient computed by the correction coefficient computing circuit by white noise stored in the white noise storage. The present invention is constructed to compute a corrected coefficient by adding the correction value obtained as described above to a coefficient of a dequantized acoustic signal. Accordingly, it is possible to add a correction value according to white noise of suitable amount for each band depending on the level of a coefficient existing in the band. As a result, energy lost at the time of quantization is interpolated by suitable amount.

A signal processing method according to the present invention for dequantizing and processing a coded acoustic signal or a coded image signal obtained by coding an acoustic signal or an image signal which has undergone orthogonal transform for each frame unit at a predetermined time comprises: a coefficient determining step of determining whether there is a null orthogonal transform coefficient in a coded acoustic signal or a coded image signal which has been dequantized, for each frequency band according to the orthogonal transform coefficient; and an adding step of adding an orthogonal transform coefficient according to a white noise source to a frequency band when it is determined in the coefficient determining step that there is a null orthogonal transform coefficient in the frequency band.

A signal processing apparatus according to the present invention for dequantizing and processing a coded acoustic signal or a coded image signal obtained by coding an acoustic signal or an image signal which has undergone orthogonal transform for each frame unit at a predetermined time comprises: a coefficient determining circuit for determining whether there is a null orthogonal transform coefficient in a coded acoustic signal or a coded image signal which has been dequantized, for each frequency band according to the orthogonal transform coefficient; and an adding circuit for adding an orthogonal transform coefficient according to a white noise source to a frequency band when it is determined by the coefficient determining circuit that there is a null orthogonal transform coefficient in the frequency band.

The white noise source according to the present invention is constituted of orthogonal transform coefficients obtained by dividing white noise at a time corresponding to the frame into a plurality of bands and applying orthogonal transform for each band.

The adding circuit according to the present invention is constructed to add an orthogonal transform coefficient according to a predetermined band read out from a white noise source to a frequency band when it is determined by the coefficient determining circuit that there is a null orthogonal transform coefficient in the frequency band.

A computer-readable recording medium, which records therein a program for causing a computer to dequantize and process a coded acoustic signal or a coded image signal obtained by coding an acoustic signal or an image signal that has undergone orthogonal transform for each frame unit at a predetermined time, comprises: a coefficient determining step of determining whether there is a null orthogonal transform coefficient in a coded acoustic signal or a coded image signal which has been dequantized, for each frequency band according to the orthogonal transform coefficient; and an adding step of adding an orthogonal transform coefficient according to a white noise source to a frequency band when it is determined in the coefficient determining step that there is a null orthogonal transform coefficient in the frequency band.

In the present invention, a signal processing apparatus dequantizes and processes a coded acoustic signal or a coded image signal obtained by coding an acoustic signal or an image signal which has undergone orthogonal transform for each frame unit at a predetermined time. The coefficient determining circuit determines whether there is a null orthogonal transform coefficient in a coded acoustic signal or a coded image signal which has been dequantized, for each frequency band. Then, the adding circuit adds an orthogonal transform coefficient according to a white noise source to a frequency band when it is determined that there is a null orthogonal transform coefficient in the frequency band. Accordingly, it becomes possible to suitably interpolate energy for a part for which an orthogonal is lost due to quantization error.

Moreover, in the present invention, an orthogonal transform coefficient according to a predetermined band read out from a white noise source constituted of orthogonal transform coefficients obtained by dividing white noise at a time corresponding to the frame into a plurality of bands and applying orthogonal transform for each band is added to a frequency band when it is determined by the coefficient determining circuit that there is a null orthogonal transform coefficient in the frequency band.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the hardware structure of a conventional decoding apparatus;

FIG. 2 is a block diagram showing the hardware structure of a decoding apparatus which is a signal processing apparatus;

FIG. 3 is a graph showing a change in an IMDCT coefficient to a frequency;

FIG. 4 is a block diagram showing the hardware structure of an interpolation processor;

FIG. 5 is an explanatory view showing the record layout of a white noise storage;

FIG. 6 is a flow chart showing the computation procedure of a corrected coefficient;

FIG. 7 is a block diagram showing the hardware structure of an interpolation processor according to Embodiment 2;

FIGS. 8A and 8B are a flow chart showing the computation process procedure of a corrected minimum value;

FIGS. 9A and 9B are graphs showing comparison of a correction coefficient between a case where a determining circuit is not used and a case where a determining circuit is used;

FIG. 10 is a graph showing a result of comparison with a conventional technique;

FIG. 11 is a block diagram showing the structure of a signal processing apparatus according to Embodiment 3;

FIG. 12 is a block diagram showing the hardware structure of an interpolation processor according to Embodiment 4;

FIG. 13 is an explanatory view showing the record layout of a second white noise storage;

FIG. 14 is a flow chart showing the procedure of a selection process of a first white noise storage or the second white noise storage;

FIG. 15 is a flow chart showing the procedure of a selection process of a block;

FIG. 16 is a block diagram showing the structure of a signal processing apparatus according to Embodiment 5;

FIG. 17 is a block diagram showing the hardware structure of a decoding apparatus according to Embodiment 6;

FIG. 18 is a flow chart showing the procedure of a tonality judging process;

FIG. 19 is a block diagram showing the structure of a signal processing apparatus according to Embodiment 7;

FIG. 20 is a block diagram showing the hardware structure of a decoding apparatus according to Embodiment 8;

FIG. 21 is an explanatory view showing the record layout of a table;

FIG. 22 is a flow chart showing the procedure of a comparison process;

FIG. 23 is a block diagram showing the structure of a signal processing apparatus according to Embodiment 9;

FIG. 24 is a block diagram showing the hardware structure of an interpolation processor according to Embodiment 10;

FIG. 25 is a flow chart showing the procedure of an adding process of white noise; and

FIG. 26 is a block diagram showing the structure of a signal processing apparatus according to Embodiment 11.

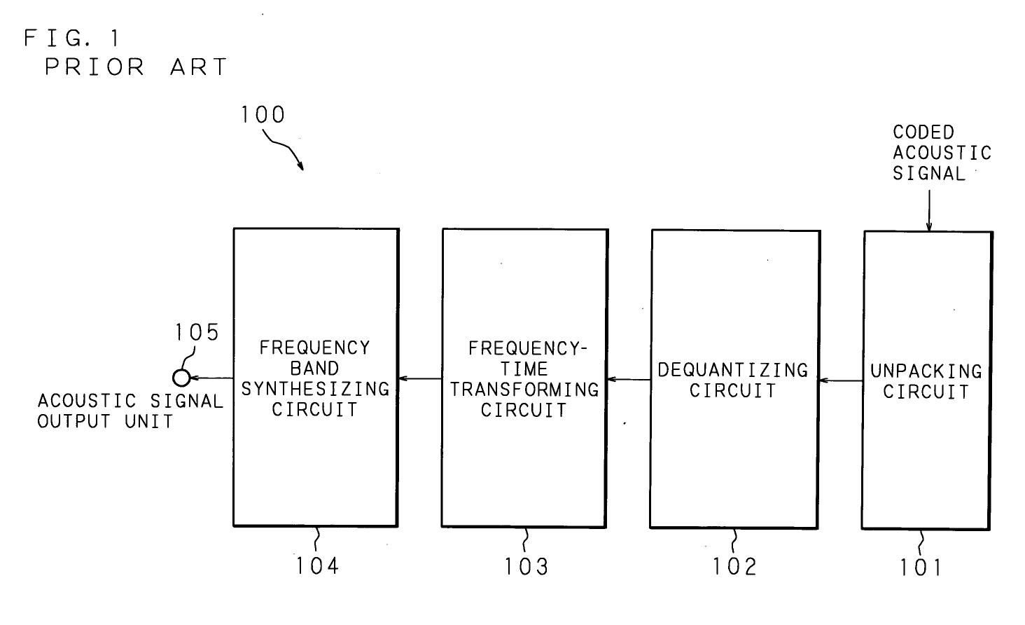

### DESCRIPTION OF THE PREFERRED EMBODIMENTS

### Embodiment 1

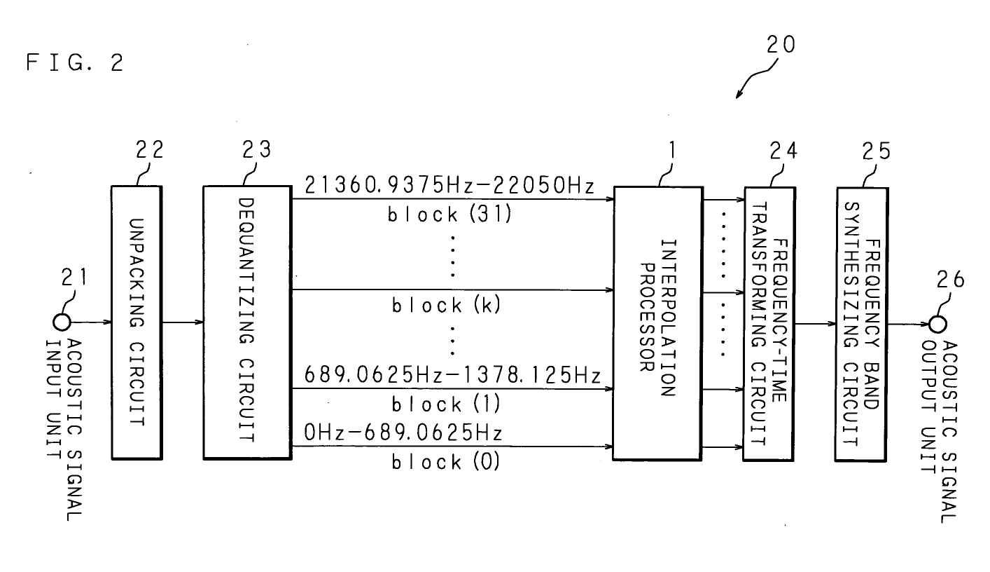

The following description will explain an embodiment of the present invention with reference to the drawings. FIG. 2 is a block diagram showing the hardware structure of a decoding apparatus which is a signal processing apparatus. Denoted at 20 in the figure is a decoding apparatus for decoding a coded acoustic signal and comprises an acoustic signal input unit 21, an unpacking circuit 22, a dequantizing circuit 23, an interpolation processor 1, a frequency-time transforming circuit 24, a frequency band synthesizing circuit 25 and an acoustic signal output unit 26. It should be noted that, though the present embodiment is explained using an example wherein the MP3 is applied as a compression coding method, other methods may be applied similarly.

A coded acoustic signal read out from recording medium, a coded acoustic signal received by a digital tuner or the like is inputted into the acoustic signal input unit 21 and the inputted coded acoustic signal is outputted to the unpacking circuit (demultiplexer) 22. The unpacking circuit 22 unpacks the quantization coefficient, the scale factor, the scale factor multiplexer, the global gain and the subblock gain respectively from frame information of the acoustic signal. The acoustic signal is dequantized into an IMDCT coefficient at the dequantizing circuit 23 using the unpacked quantization coefficient, the quantization bit rate, the scale factor, the scale factor multiplexer, the global gain and the subblock gain. The dequantizing circuit 23 outputs an IMDCT coefficient shown by the next expression (1) for each frequency band depending on the block length (a long block or a short block).

Expression (1)

$$long block \text{:} \\ I ( m ) = sgn ( MK ( m ) ) \times {\vert MK ( m ) \vert}^{\frac{4}{3}} \times … {2}^{\frac{1}{4} ( global\_gain [ gr ] - 210 )} \times {2}^{- ( scalefac\_multiplier \times ( scalefac [ sfb ] + preflag [ gr ] \times pretab [ sfb ] ) )} \\ Short block \text{:} \\ I ( m ) = sgn ( MK ( m ) ) \times {\vert MK ( m ) \vert}^{\frac{4}{3}} \times … {2}^{\frac{1}{4} ( global\_gain [ gr ] - 210 - 8 \times subblock\_gain [ gr ] [ wnd ] )} \times {2}^{- ( scalefac\_multiplier \times scalefac [ gr ] [ wnd ] [ sfb ] )} \qquad ( 1 )$$

### I(m):IMDCT coefficient

### MK(m): quantization coefficient (Hoffman decoding value)

scalefac_multiplier=[1,0.5]
gr: granule, wnd: window, sjb: scalefactorband

The variable “m” in the expression (1) indicates the index of the IMDCT coefficient, “MK(m)” indicates the quantization coefficient (Huffman decoding value), “sgn(MK(m))” indicates the sign of the quantization coefficient, “scalefac_multiplier” indicates 1 or 0.5, “gr” indicates the index of granule, “wnd” indicates the index of the form of the window, “sfb” indicates the index of the scale factor band, “preflag[gr]” indicates an existence flag of the preemphasis which is 0 or 1, and “pretab[sfb]” indicates a value obtained by a predetermined preemphasis table. It should be noted that the scale factor (which can be represented by each six bits and designated by approximately 2 dB, for example) in ATRAC is the same as a value relating to the scale factor in MP3. The value relating to the scale factor in MP3 is computed using the scale factor, the scale factor multiplexer, the global gain, the subblock gain (a part of the expression (1) after the multiplier of 2), the existence flag of the preemphasis and a value obtained by the preemphasis table, as shown in the expression (1). The following description will explain the scale factor in ATRAC and values relating to the scale factor in MP3 collectively as a scale factor. Here, the scale factor means a characteristic part represented by a mantissa part and an exponent part in order to represent a spectrum of each predetermined frequency band which is divided. For example, in MP3, a spectrum of each predetermined frequency band which is divided is normalized to have the maximum value of 1.0, and the characteristic part thereof is coded as a scale factor, a global gain and a subblock gain. The scale factor, the global gain and the exponent part of the subblock gain mentioned above are named generically as a value relating to a scale factor.

In the present embodiment, IMDCT coefficients I(0), I(1), . . . , I(m), . . . , I(575) are outputted for each of 32 frequency bands block (0)-block (31) as shown in the figure. When the sampling frequency is 44.1 kHz, the frequency of a block (0) is 0 Hz-689.0625 Hz, a block (1) is 689.0625 Hz-1378.125 Hz and a block (31) is 21360.9375 Hz-22050 Hz. It should be noted that a block of an arbitrary frequency band is hereinafter referred to as a block (k). Here, “k” is an integer and satisfies 0≦k≦31. The IMDCT coefficients I(0)-I(575) for the respective frequency bands are inputted into the interpolation processor 1.

An IMDCT coefficient for each frequency band is composed of a plurality of coefficients (spectrums) depending on the block length. An IMDCT coefficient of a long block is composed of 18 coefficients and an IMDCT coefficient of a short block is composed of 6 coefficients. It should be noted that the following description will explain the present embodiment using an example wherein the block length is a long block. Moreover, explanation will be made while referring to one granule as one frame hereinafter, as 576 samples of IMDCT coefficients compose one granule and 1152 coefficient samples, the sum of granule 0 and granule 1, are processed as one frame.

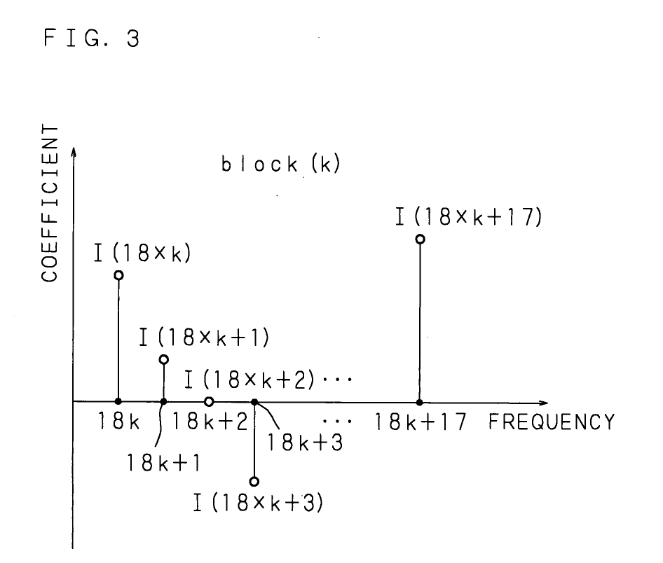

FIG. 3 is a graph showing a change in an IMDCT coefficient to a frequency. The frequency is shown on the abscissa axis and the coefficient is shown on the ordinate axis. When the IMDCT coefficient (which will be hereinafter represented by a coefficient I(m)) is a long block, 18 coefficients I(18×k) to I(18×k+17) are included in a frequency band. In the graph of FIG. 3, a change in the coefficients I(18×k), I(18×k+1), . . . , I(18×k+17) is shown with respect to frequencies 18×k, 18×k+1, . . . , 18×k+17. The coefficient takes a positive, negative or null value.

In FIG. 2, the coefficient I(m) is inputted into the interpolation processor 1, and a corrected coefficient I(m) obtained by adding a correction value relating to white noise is outputted from the interpolation processor 1. The frequency-time transforming circuit 24 applies an IMDCT process so as to transform the coefficient into an acoustic signal on a time axis. The inverted acoustic signal further undergoes band synthesis by an IPFB (Inverse Polyphase Filter Bank), which is a band synthesizing filter, at the frequency band synthesizing circuit 25 and then outputted to the acoustic signal output unit 26.

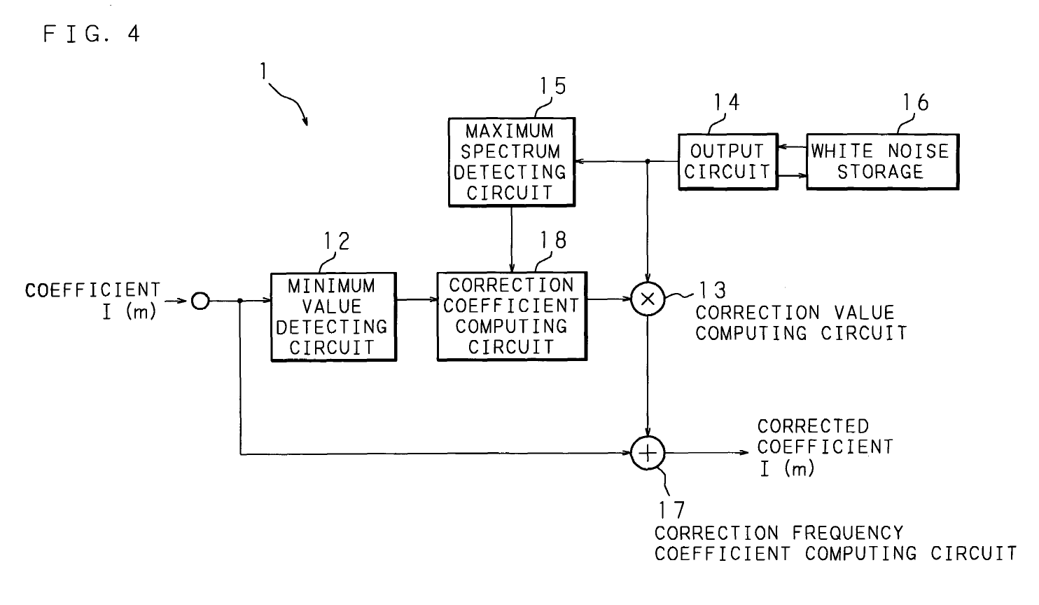

FIG. 4 is a block diagram showing the hardware structure of the interpolation processor 1. The interpolation processor 1 comprises a minimum value detecting circuit 12 which functions as a level detecting circuit, a correction coefficient computing circuit 18, a correction value computing circuit 13, a white noise storage 16, an output circuit 14, a maximum spectrum detecting circuit 15 and a correction frequency coefficient computing circuit 17. A coefficient I(m) of each frequency band outputted from the dequantizing circuit 23 is inputted to the minimum value detecting circuit 12. The minimum value detecting circuit 12 detects a minimum absolute value, excluding zero, of a coefficient (spectrum) from coefficients I(0)-I(575) of a frame. In the example of FIG. 3, detected is not I(18×k+2) which is zero, but I(18×k+1). The detected coefficient I(m) having the minimum absolute value is outputted to the correction coefficient computing circuit 18 as the minimum value. It should be noted that, though the present embodiment is constructed to detect the minimum absolute value, excluding zero, of a coefficient I(m) as a level using the minimum value detecting circuit 12 as a level detecting circuit, the present invention is not limited to this. For example, the second smallest absolute value of the coefficient I(m), or a mean value, a variance or the like of three small absolute values may be used as a level of a coefficient I(m) instead.

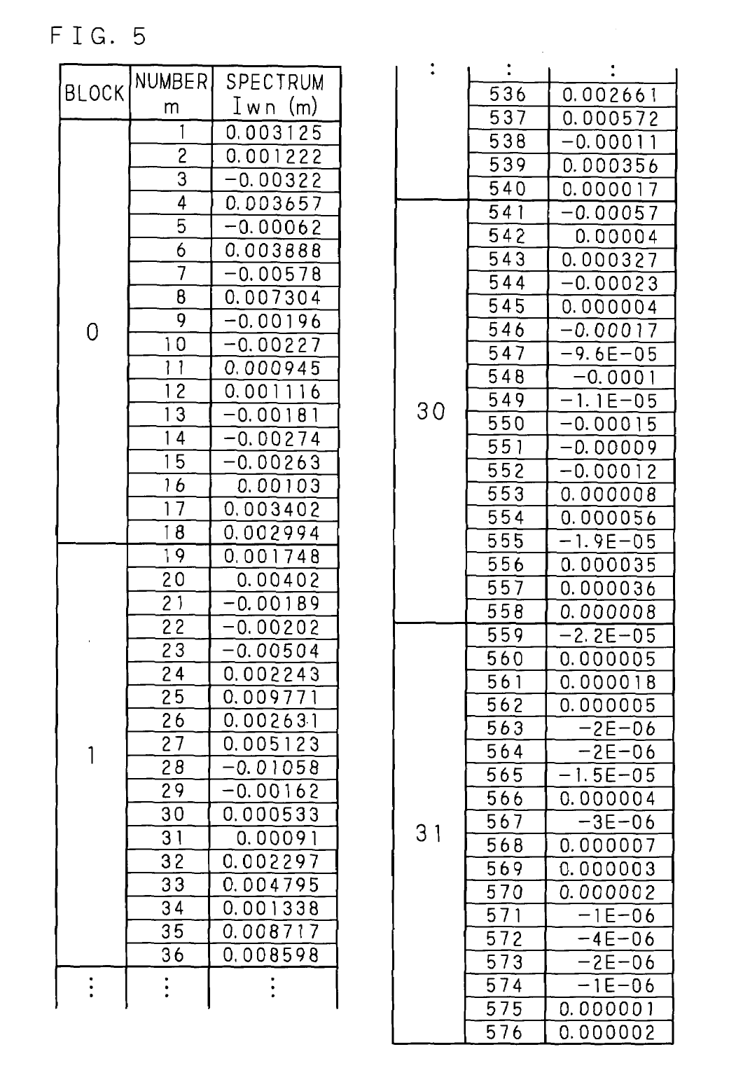

The white noise storage 16 stores a plurality of white noise (frequency component sources of white noise) for each block. FIG. 5 is an explanatory view showing the record layout of the white noise storage 16. The white noise storage 16 is composed of orthogonal transform coefficients (spectrums) which have been obtained by dividing white noise at a time corresponding to a frame into a plurality of bands (blocks) and applying orthogonal transform for each band. The white noise storage 16 comprises a block field, a number m field and a spectrum Iwn(m) field. Blocks composing white noise corresponding to a long block are stored in the block field and 32 blocks in total from a block 0 to a block 31 are prepared. A number for distinguishing a spectrum of white noise is stored for each block in the number m field.

In the spectrum Iwn(m) field, a spectrum of white noise is stored corresponding to each number m. In the present embodiment, 18 spectrums are stored for one block and 576 spectrums in total are stored for all 32 blocks. For example, a spectrum “0.003125” of white noise is stored for a number “1” of a block “0”. The spectrum of white noise may be set so that the average of all the spectrums becomes a predetermined value, e.g., approximately −20 dB. It should be noted that the Iwn(m) is a table for creating white noise of a level of approximately half of the minimum value of I(m) and the present invention is not necessarily limited to a value of approximately −20 dB. In the white noise storage 16, transform coefficient (spectrum) data obtained by preliminarily applying time-frequency transform for a white noise source of a time signal at the time of compression is stored and prepared in a memory or the like corresponding to a block length. That is, the transform coefficient data is composed of orthogonal transform coefficients obtained by dividing white noise for a frame into a plurality of bands and applying orthogonal transform for each band. In the case of a long block, transform coefficients which are divided into 18 pieces of time data by frequency division at the time of compression and transformed into 18 pieces of frequency component data are stored in a memory or the like. In the case of a short block, transform coefficients which are divided into 6 pieces of time data by frequency division at the time of compression and transformed into 6 pieces of frequency component data are stored in a memory or the like. It should be noted that explained in the present embodiment is a form wherein prepared white noise is used for ease of explanation. However, white noise having a whole mean spectrum equal to or smaller than a predetermined value may be generated sequentially by a random number generator or the like, which is not illustrated, in the apparatus, and outputted after being temporarily stored in the white noise storage 16.

The output circuit 14 connected with the white noise storage 16 selects a plurality of blocks of the white noise storage 16 at random or regularly and outputs spectrums according to white noise of the selected blocks to a maximum spectrum detecting circuit 15 and the correction value computing circuit 13. The maximum spectrum detecting circuit 15 detects a maximum value according to an absolute value of a spectrum in a block outputted from the output circuit 14. It should be noted that the maximum spectrum detecting circuit 15 in the present embodiment detects a maximum value of the spectrum. However, a mean spectrum detecting circuit (not illustrated) may be provided instead of the maximum spectrum detecting circuit 15 so as to detect the mean value of a spectrum in the block. A spectrum (or spectrum mean value) of white noise having the maximum absolute value detected by the maximum spectrum detecting circuit 15 is outputted to the correction coefficient computing circuit 18. It should be noted that a maximum spectrum detecting circuit 15 or a mean spectrum detecting circuit is provided in the present embodiment so as to output a maximum value or a mean value of white noise. However, the present invention is not limited to this form as long as a level of white noise is detected. For example, a mean value, a variance or the like of a plurality of spectrums having large values of white noise of a selected block may be detected.

The correction coefficient computing circuit 18 computes a correction coefficient by dividing a minimum value of a coefficient I(m) outputted from the minimum value detecting circuit 12 by a value which is twice the maximum value (or the mean value) of a spectrum of white noise. The correction coefficient computing circuit 18 outputs the computed correction coefficient to the correction value computing circuit 13. It should be noted that, though the minimum value of the coefficient I(m) in the present embodiment is divided by a value which is twice the maximum value (or the mean value) of a spectrum of white noise, this is only an example and the minimum value may divided by a value which is three times the maximum value or the like. The correction value computing circuit 13 multiplies a spectrum according to white noise of one block outputted from the output circuit 14 as a value relating to white noise to be corrected by a correction coefficient outputted from the correction coefficient computing circuit 18 so as to compute a correction value to be used for correction of the coefficient I(m). For example, when spectrums Iwm(1)-Iwm(18) of white noise of a block “0” are outputted, each spectrum is multiplied by a correction coefficient so as to computes correction value which is a value relating to white noise of “18”. The correction frequency coefficient computing circuit 17 adds the correction value outputted from the correction value computing circuit 13 to a coefficient I(m) so as to compute a corrected coefficient I(m). The corrected coefficient I(m) is outputted to the frequency-time transforming circuit 24. In the above example, 18 correction values are respectively added to coefficients I(18×k)-I(18×k+17) so as to compute corrected coefficients I(18×k)-I(18×k+17). Here, the same value is used for the correction coefficients computed by the correction coefficient computing circuit 18 between frequency bands 0≦k≦31. Moreover, white noise according to a block which is selected from the output circuit 14 at random or regularly and outputted to the correction value computing circuit 13 may be used for a spectrum of white noise according to the same block between frequency bands 0≦k≦31. A spectrum of white noise according to a different block which is selected between frequency bands 0≦k≦31 again at random or regularly may also be used. It should be noted that it is unnecessary to add a correction value to a frequency band according to a quantization value which is not zero.

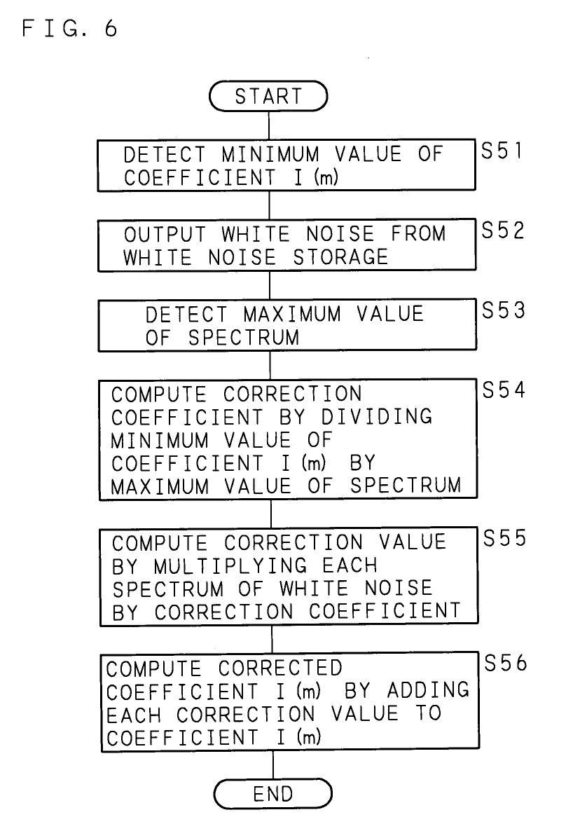

The following description will explain processing of each hardware described above using a flow chart. FIG. 6 is a flow chart showing the computation procedure of a corrected coefficient. First, the minimum value detecting circuit 12 detects the minimum absolute value of a coefficient, excluding zero, of the coefficient I(m) from coefficients in one frame (step S51). The output circuit 14 connected with the white noise storage 16 selects one block of the white noise storage 16 at random or regularly and outputs white noise (spectrum) of the selected block to the maximum spectrum detecting circuit 15 and the correction value computing circuit 13 (step S52). The maximum spectrum detecting circuit 15 detects a maximum value according to the absolute value of a spectrum in the block outputted from the output circuit 14 (step S53). The spectrum (or the spectrum mean value) of white noise according to the maximum absolute value detected by the maximum spectrum detecting circuit 15 is outputted to the correction coefficient computing circuit 18.

The correction coefficient computing circuit 18 computes a correction coefficient by dividing a minimum value of a coefficient I(m) outputted from the minimum value detecting circuit 12 by a value which is twice the maximum value (or the mean value) of a spectrum of white noise (step S54). The correction coefficient computing circuit 18 outputs the computed correction coefficient to the correction value computing circuit 13. The correction value computing circuit 13 multiplies each spectrum according to white noise of the block outputted from the output circuit 14 at random or regularly by the correction coefficient outputted from the correction coefficient computing circuit 18 so as to compute a correction value to be used for correction of the coefficient I(m) (step S55). The correction frequency coefficient computing circuit 17 adds each correction value outputted from the correction value computing circuit 13 to the coefficient I(m) so as to compute a corrected coefficient I(m) (step S56). For example, when the correction coefficient computed in the step S54 is indicated by J, correction values Iwn′(1)-Iwn′(18) are computed by multiplying spectrums Iwn(1)-Iwn(18) in the block 0 shown in FIG. 5 by J. Corrected coefficients I′(0)-I′(17) can be then obtained by adding the correction values Iwn′(1)-Iwn′(18) to the coefficients I(0)-I(17) in the block (0). The same goes for coefficients I(18)-I(35) in the next block (1). That is, correction values Iwn′(19)-Iwn′(36) are computed by multiplying spectrums Iwn(19)-Iwn(36) in the block 1 shown in FIG. 5, which is selected at random or regularly, by J. Corrected coefficients I′(18)-I′(35) can be then obtained by adding correction values Iwn′(19)-Iwn′(36) to the coefficients I(18)-I(35) in the block (1). Such a process is repeatedly applied to different blocks. Since a correction value computed based on white noise and a minimum value of an IMDCT coefficient is added to the IMDCT coefficient as described above, the most suitable amount of white noise matching the sound pressure can be added and it becomes possible to suitably complement energy lost in dequantization.

### Embodiment 2

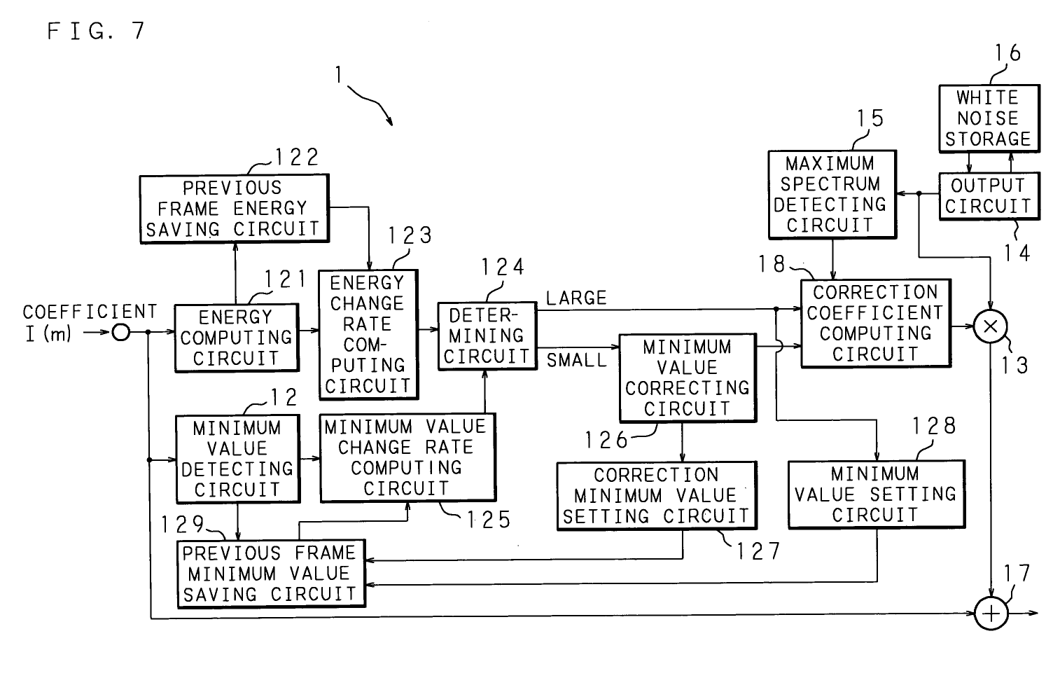

Embodiment 2 relates to a form for correcting a minimum value detected by a minimum value detecting circuit 12. FIG. 7 is a block diagram showing the hardware structure of an interpolation processor 1 according to Embodiment 2. The interpolation processor 1 according to Embodiment 2 comprises an energy computing circuit 121, a previous frame energy saving circuit 122, an energy change rate computing circuit 123, a determining circuit 124, a minimum value correcting circuit 126, a minimum value change rate computing circuit 125, a correction minimum value setting circuit 127, a minimum value setting circuit 128 and a previous frame minimum value saving circuit 129, in addition to the structure of Embodiment 1. It should be noted that a frame, which means a time interval of a unit of coding (decoding) processing, processed a time corresponding to one frame before a frame which is now being processed is hereinafter referred to as a previous frame.

A coefficient I(m) of a frequency band is inputted into the energy computing circuit 121, the minimum value detecting circuit 12 and the correction frequency coefficient computing circuit 17. The energy computing circuit 121 computes energy based on the coefficient I(m) squared, i.e., the summation of power spectrums. Said energy is computed by obtaining the summation of coefficients squared of frequency bands I(0)-I(575) of a frame, as shown in the expression (2). Though energy is used in the above technique, a mean power spectrum computed by division by the number of spectrums, e.g. 576, may be used as shown in the expression (3). The following description will explain an example wherein the energy computing circuit 121 computes energy.

Expression (2)

$$E = {\sum }_{m = 0}^{M} {I ( m )}^{2} \\ m = 1 , 2 … M \qquad ( 2 )$$

Expression (3)

$$E = {\sum }_{m = 0}^{M} {I ( m )}^{2} / M \\ m = 1 , 2 … M \qquad ( 3 )$$

Here, “E” indicates energy of one frame and “m” is a natural number, a maximum value of which is “M”. In the example of FIG. 7, the energy is computed by obtaining the summation of I(0)-I(575) squared. The previous frame energy saving circuit 122 saves the energy of the previous frame computed by the energy computing circuit 121. The energy of the previous frame saved in the previous frame energy saving circuit 122 and the energy computed by the energy computing circuit 121 are respectively inputted into the energy change rate computing circuit 123. As shown in the expression (4), the energy change rate computing circuit 123 divides the energy computed by the energy computing circuit 121 by the energy of the previous frame outputted from the previous frame energy saving circuit 122 and computes the square root thereof so as to compute the energy change rate. That is, computed is a rate of change between the energy of a unit of decoding processing (frame) at a predetermined time computed by the energy computing circuit 121 and the energy of a unit of decoding processing (frame) before the predetermined time saved in the previous frame energy saving circuit 122.

### Expression (4)

ER=\sqrt{E/Ep} (4)

Here, “Ep” indicates the energy of the previous frame and “ER” indicates the energy change rate. It should be noted that Embodiment 2 is constructed to compute the energy change rate by dividing the energy by the previous energy and compute the square root. However, the present invention is not limited to this as long as energy fluctuation between frames can be computed. For example, a rate of change can be obtained by subtracting the computed energy from the previous energy and squaring the result, or, by contraries, dividing the previous energy by the energy computed by the energy computing circuit 121 and computing the square root.

The computed energy change rate is outputted to the determining circuit 124. From coefficients I(m) inputted into the minimum value detecting circuit 12, a coefficient I(m) according to the minimum absolute value, excluding zero, in the frequency band is detected as described in Embodiment 1. The previous frame minimum value saving circuit 129 saves the minimum value of the previous frame detected by the minimum value detecting circuit 12. The minimum value of the previous frame saved in the previous frame minimum value saving circuit 129 and the minimum value detected by the minimum value detecting circuit 12 are respectively inputted into the minimum value change rate computing circuit 125. The minimum value change rate computing circuit 125 computes the minimum value change rate by dividing the minimum value detected by the minimum value detecting circuit 12 by the minimum value of the previous frame outputted from the previous frame minimum value saving circuit 129. That is, computed is a rate of change between the minimum value of a unit of decoding processing (frame) at a predetermined time detected by the minimum value detecting circuit 12 and the minimum value of a unit of decoding processing (frame) before the predetermined time saved in the previous frame minimum value saving circuit 129. It should be noted that the rate of change of the minimum value may be computed by, for example, subtracting the minimum value of the previous frame from the detected minimum value and squaring the result or, by contraries, dividing the minimum value of the previous frame by the detected minimum value, as long as fluctuation from the minimum value of the previous frame can be computed.

The determining circuit 124 compares the energy change rate outputted from the energy change rate computing circuit 123 with the minimum value change rate outputted from the minimum value change rate computing circuit 125 so as to determine whether the energy change rate is larger than the minimum value change rate or not. This is for correcting the minimum value as described in Embodiment 1 when the fluctuation of the minimum value between frames is large, using the energy change rate between frames as a comparison object, as a threshold of determination. When determining that the energy change rate is larger than the minimum value change rate, the determining circuit 124 outputs the minimum value detected by the minimum value detecting circuit 12 to the correction coefficient computing circuit 18 and the minimum value setting circuit 128 since it is unnecessary to make correction. The minimum value setting circuit 128 outputs said minimum value to the previous frame minimum value saving circuit 129 so that the previous frame minimum value saving circuit 129 saves said minimum value as the minimum value of the previous frame. That is, the minimum value outputted from the minimum value setting circuit 128 is used as the minimum value of a previous frame outputted from the previous frame minimum value saving circuit 129 for computing the minimum value change rate of the next frame.

On the other hand, when determining that the energy change rate is smaller than the minimum value change rate, the determining circuit 124 outputs the energy change rate and the minimum value of the previous frame to the minimum value correcting circuit 126. The minimum value correcting circuit 126 corrects the minimum value so that the minimum value change rate and the energy change rate become equal. In particular, the minimum value is corrected so as to satisfy a conditional expression shown by the expression (5).

### Expression (5)

ER=MSR (5)

Here, “MSR” indicates the minimum value change rate obtained by dividing the minimum value of a coefficient I(m) by the minimum value of the previous frame. The minimum value change rate on the right-hand side of the expression (5) can be modified to one obtained by dividing the minimum value, excluding zero, of |I(m)| by the minimum value, excluding zero, of |I(m)| of the previous frame as shown in the expression (6). The corrected minimum value to be obtained is a value obtained by multiplying the energy change rate ER by the minimum value of the previous frame. The minimum value correcting circuit 126 outputs the minimum value corrected as described above to the correction minimum value setting circuit 127 and the correction coefficient computing circuit 18. The correction minimum value setting circuit 127 outputs said corrected minimum value to the previous frame minimum value saving circuit 129 similarly to the minimum value setting circuit 128 so that the corrected minimum value is saved as the minimum value of the previous frame.

### Expression (6)

$$MSR = \frac{minimum value}{minimum value of the previous frame} \qquad ( 6 )$$

The previous frame minimum value saving circuit 129 saves the minimum value outputted from the correction minimum value setting circuit 127 or the minimum value setting circuit 128. The previous frame minimum value saving circuit 129 outputs the minimum value outputted from the correction minimum value setting circuit 127 or the minimum value setting circuit 128 to the minimum value change rate computing circuit 125. It should be noted that the present Embodiment 2 is constructed to correct the minimum value so that the minimum value change rate and the energy change rate become equal. However, it is unnecessary to correct the minimum value so that the minimum value change rate becomes equal to the energy change rate strictly and all that is required is to correct the minimum value so that the minimum value change rate becomes roughly equal to the energy change rate and there may be some error. The corrected minimum value outputted from the minimum value correcting circuit 126 is outputted to the correction coefficient computing circuit 18.

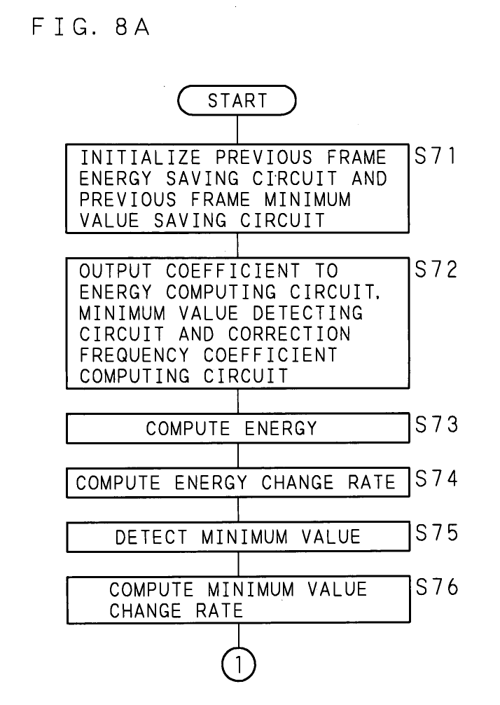

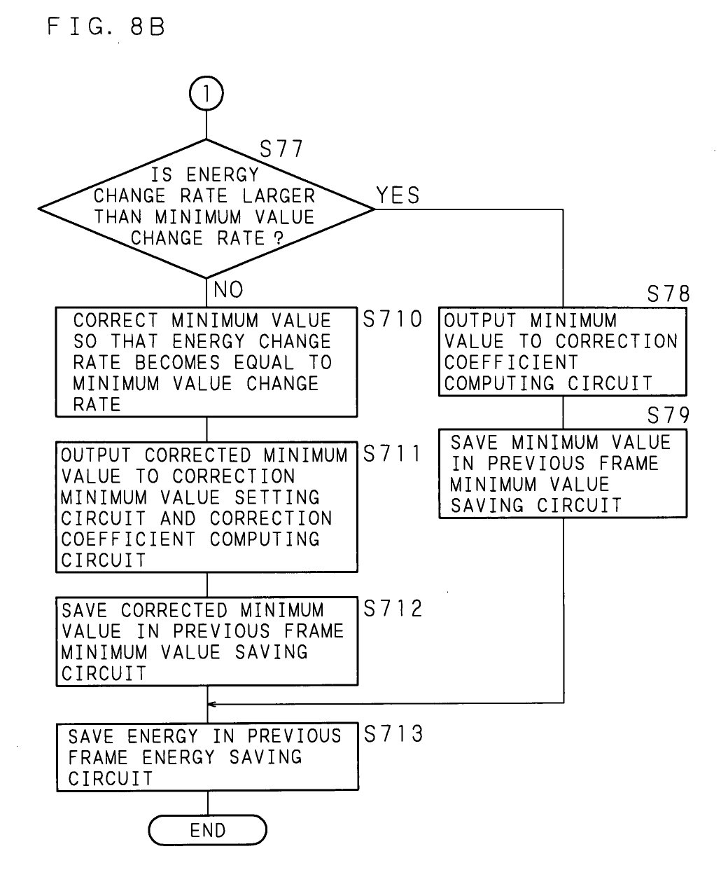

Regarding the above hardware structure, the following description will explain the computation process procedure of a corrected minimum value using a flow chart. FIGS. 8A and 8B are a flow chart showing the computation process procedure of a corrected minimum value. First, the saved content of the previous frame energy saving circuit 122 and the previous frame minimum value saving circuit 129 are initialized (step S71). In particular, the energy of the previous frame and the minimum value of the previous frame are set to 1. Such a process is a process for preventing occurrence of an infinite solution in the energy change rate computing circuit 123 and the minimum value change rate computing circuit 125 by assigning 0 to the denominator when a corrected coefficient for the first frame is computed. In processes after the next frame, the computed energy and minimum value of the previous frame are saved and utilized. It should be noted that the process is started from Start when there is a silent frame in the middle of music.

A coefficient I(m) of a frequency band is outputted to the energy computing circuit 121, the minimum value detecting circuit 12 and the correction frequency coefficient computing circuit 17 (step S72). The energy computing circuit 121 computes the energy of the coefficient I(m) (step S73). The energy of the previous frame saved in the previous frame energy saving circuit 122 and the energy computed by the energy computing circuit 121 are respectively inputted into the energy change rate computing circuit 123. The energy change rate computing circuit 123 divides the energy computed by the energy computing circuit 121 by the energy of the previous frame outputted from the previous frame energy saving circuit 122 and computes the square root so as to compute the energy change rate (step S74). The previous frame energy saving circuit 122 outputs the saved energy of the previous frame to the energy change rate computing circuit 123 and then saves the energy outputted from the energy computing circuit 121 as the energy of the previous frame to be used in computation of the next frame.

The computed energy change rate is outputted to the determining circuit 124. The minimum value detecting circuit 12 detects a coefficient I(m) according to the minimum absolute value based on the inputted coefficient I(m) (step S75). The minimum value of the previous frame saved in the previous frame minimum value saving circuit 129 and the minimum value detected by the minimum value detecting circuit 12 are respectively inputted into the minimum value change rate computing circuit 125. The minimum value change rate computing circuit 125 divides the minimum value detected by the minimum value detecting circuit 12 by the minimum value of the previous frame outputted from the previous frame minimum value saving circuit 129 so as to compute the minimum value change rate (step S76).

The determining circuit 124 compares the energy change rate outputted from the energy change rate computing circuit 123 and the minimum value change rate outputted from the minimum value change rate computing circuit 125 so as to determine whether the energy change rate is larger than the minimum value change rate or not (step S77). When determining that the energy change rate is larger than the minimum value change rate (YES in the step S77), the determining circuit 124 outputs the minimum value detected by the minimum value detecting circuit 12 to the correction coefficient computing circuit 18 (step S78). The minimum value is outputted also to the minimum value setting circuit 128. The minimum value setting circuit 128 outputs the minimum value to the previous frame minimum value saving circuit 129 so as to save said minimum value as the minimum value of the previous frame and the previous frame minimum value saving circuit 129 saves the minimum value outputted from the minimum value setting circuit 128 (step S79).

On the other hand, when determining that the energy change rate is smaller than the minimum value change rate (NO in the step S77), the determining circuit 124 outputs the minimum value of the previous frame and the energy change rate to the minimum value correcting circuit 126 and the minimum value correcting circuit 126 corrects the minimum value so that the minimum value change rate and the energy change rate become equal (step S710). In particular, the minimum value correcting circuit 126 computes a corrected minimum value by multiplying the minimum value of the previous frame by the energy change rate as described above. The minimum value correcting circuit 126 outputs the corrected minimum value which has been computed to the correction minimum value setting circuit 127 and the correction coefficient computing circuit 18 (step S711). The correction minimum value setting circuit 127 outputs said corrected minimum value to the previous frame minimum value saving circuit 129 so as to save the corrected minimum value as the minimum value of the previous frame, similarly to the minimum value setting circuit 128.

The previous frame minimum value saving circuit 129 saves the minimum value outputted from the correction minimum value setting circuit 127 (step S712). After the process of the steps S79 and S712, the energy computing circuit 121 saves the energy computed in the step S73 in the previous frame energy saving circuit 122 (step S713). The minimum value outputted in the step S78 or the minimum value outputted in the step S711 is outputted to the correction coefficient computing circuit 18. Since the subsequent process is the same as the steps S 52 to S56 in FIG. 6, the detail explanation will be omitted. As described above, by focusing attention on the energy change rate and the minimum value change rate between frames and reducing the minimum value change rate when the minimum value change rate is noticeable, it is possible to correct the minimum value and, furthermore, reduce the fluctuation of the correction value according to white noise to be added to the coefficient I(m), and an unnatural interpolation process between frames is prevented as a result.

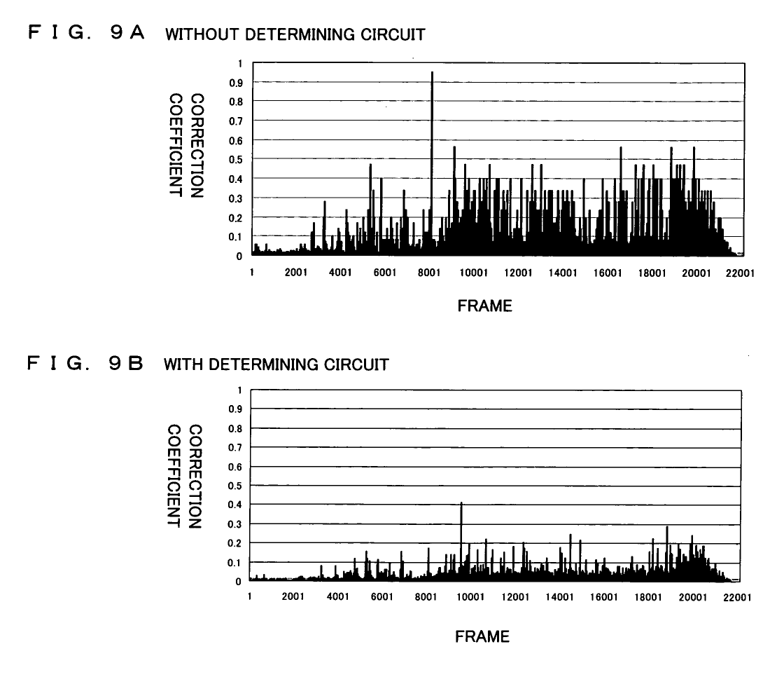

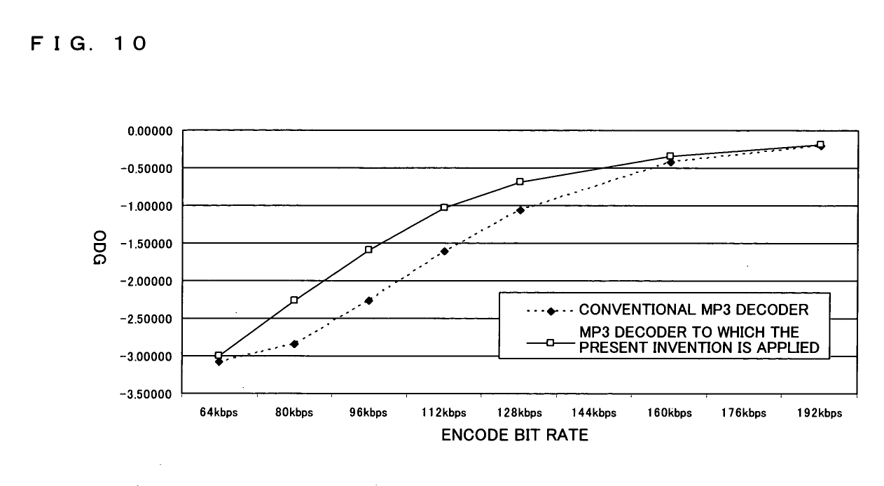

FIGS. 9A and 9B are graphs showing comparison of a correction coefficient between a case where the determining circuit 124 is not used and a case where the determining circuit 124 is used. FIG. 9A is a graph showing a change in a correction coefficient wherein the process in the determining circuit 124, i.e. a comparison process between the energy change rate and the minimum value change rate, is not performed. In the graph of FIG. 9A, a frame is shown on the abscissa axis and a correction coefficient (which is obtained by dividing the minimum value of the coefficient I(m) by the maximum value of the spectrum of white noise) computed by the correction coefficient computing circuit 18 is shown on the ordinate axis. It should be noted that the correction coefficient “1” is set to −20 dB. The graph in FIG. 9A shows a change in the correction coefficient for each frame, and outstanding correction coefficients are found in some parts.

FIG. 9B is a graph showing a change in a correction coefficient wherein the process in the determining circuit 124, i.e. a comparison process between the energy change rate and the minimum value change rate, is performed. When the graph in FIG. 9B is compared with the graph in FIG. 9A, it can be understood that the outstanding correction coefficients are decreased. As shown in FIG. 9, by suitably correcting the minimum value in view of the energy change rate and the minimum value change rate between frames, it becomes possible to add a correction value having little fluctuation even to the coefficient I(m) and realize reproduction of more natural original sound.

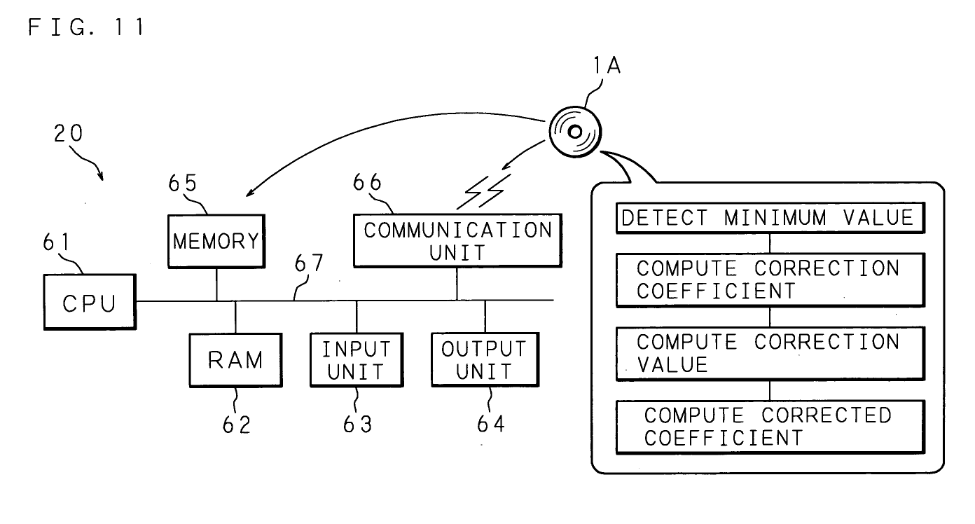

FIG. 10 is a graph showing a result of comparison with a conventional technique. In FIG. 10, an encode bit rate is shown on the abscissa axis and the unit thereof is kbps (bits per second). An ODG (Objective Difference Grade) is shown on the ordinate axis. The continuous line shows a change in the ODG for each encode bit rate in an MP3 decoder to which the present technique is applied and the dotted line shows a change in the ODG for each encode bit rate in a conventional MP3 decoder. Used for the evaluation test was a measurement method specified by CPX-2601 of JEITA (Japan Electronics and Information Technology Industries Association) and the LAME core encoder.

The evaluation specification was “ITU-R Rec. BS. 1387-1 (2001) Basic Version”, and used for the test source was averaging of eight songs of Tracks No. 27 (castanet), 32 (triangle), 35 (metallophone), 40 (harpsichord), 65 (orchestra), 66 (xylophone ensemble), 69 (pops/ABBA) and 70 (pops/E. RABBITT) of Cat No. 42204-2 (1998) EBU/Sound Quality Assessment Material recordings for subjective tests (SQAM).

The ODG is an objective evaluation value obtained as the final result of the measurement which may possibly take a negative value from 0 to −4, wherein the deterioration from the original sound is smaller as the ODG takes a larger value. “0.0” is defined as “a difference from the original sound is unrecognizable”, “−1.0” is defined as “a difference from the original sound is recognizable but does not make the listener concerned”, “−2.0” is defined as “a difference makes the listener concerned but does not hinder”, “−3.0” is defined as “a difference hinders the listener”, and “−4.0” is defined as “a difference hinders the listener a lot”. Comparing the graph in a continuous line and the graph in a dotted line in FIG. 10, it can be understood that the ODG is enhanced in the entire area and a suitable result is obtained especially from 64 kbbs to 160 kbps.

Since the present Embodiment 2 has such a structure and other structures and functions are the same as those of Embodiment 1, like codes are used to refer to like parts and detailed explanation thereof will be omitted.

### Embodiment 3

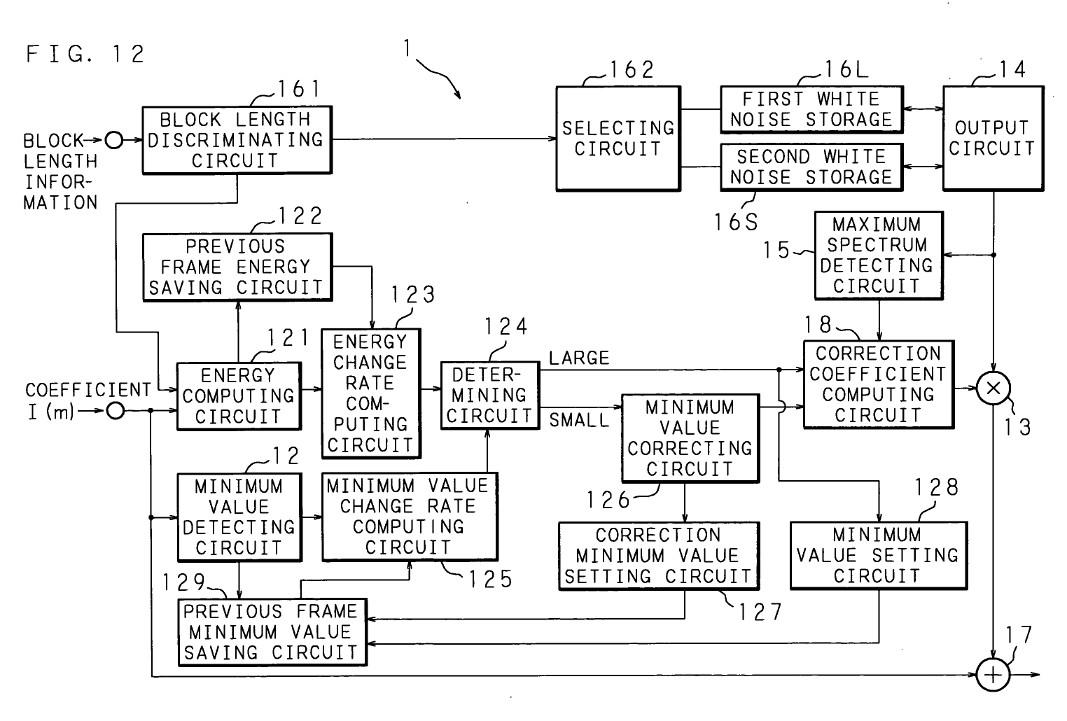

FIG. 11 is a block diagram showing the structure of a signal processing apparatus 20 according to Embodiment 3. Each process of the signal processing apparatus 20 according to Embodiment 3 may be realized by software executed by a personal computer. The following description will explain an example wherein the signal processing apparatus 20 is a personal computer 20. The personal computer 20 is a known computer comprising: a CPU (Central Processing Unit) 61; and a RAM (Random Access Memory) 62, a memory 65 such as a hard disk, an input unit 63, an output unit 64 such as a speaker and a communication unit 66, which can be connected with a communication network such as the Internet, that are connected with the CPU 61 via a bus 67.

A computer program for causing the personal computer 20 to operate can be provided in the form of a portable recording medium 1A such as a CD-ROM, an MO or a DVD-ROM as in the present Embodiment 3. Furthermore, it is also possible to download the computer program from a server computer, which is not illustrated, via the communication unit 66. The following description will explain the content thereof.

The portable recording medium 1A (CD-ROM, MO, DVD-ROM or the like) which records therein a computer program for causing a reader/writer, that is not illustrated, in the personal computer 20 shown in FIG. 11 to detect a minimum value, compute a correction coefficient, compute a correction value and compute a corrected coefficient is inserted to install said program into a control program in the memory 65. Instead, such a program may be downloaded from an external server computer, which is not illustrated, via the communication unit 66 and installed into the memory 65. Such a program is loaded into the RAM 62 for execution. In this manner, the personal computer functions as a signal processing apparatus 20 according to the present invention as described above.

Since the present Embodiment 3 has such a structure and other structures and functions are the same as those of Embodiments 1 and 2, like codes are used to refer to like parts and detailed explanation thereof will be omitted.

### Embodiment 4

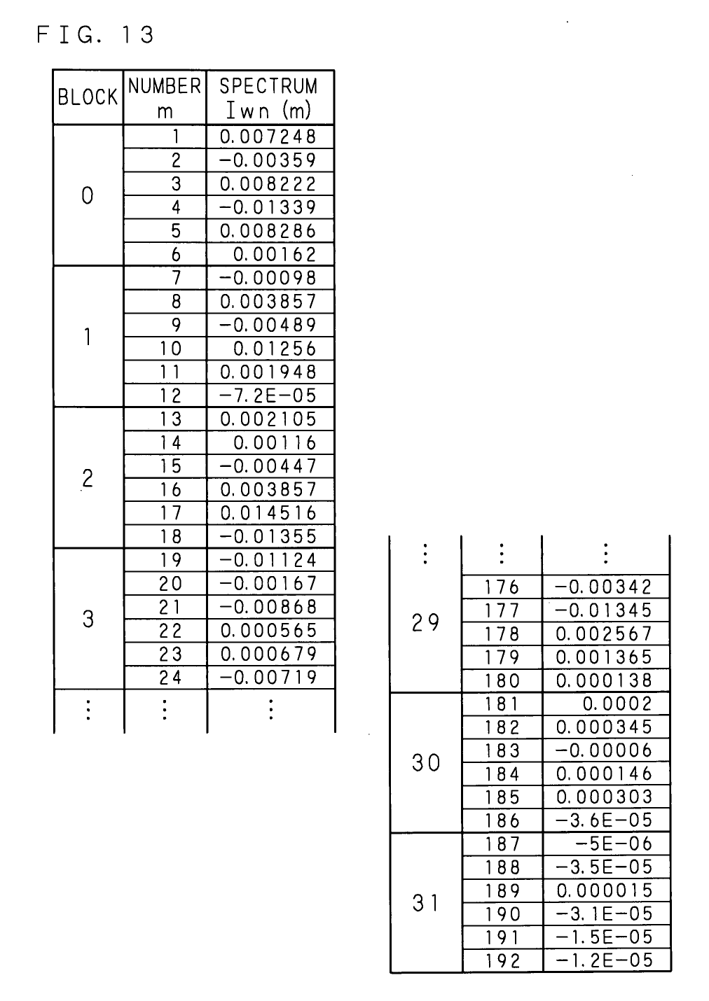

Embodiment 4 relates to a form wherein a plurality of white noise storages 16 are provided. FIG. 12 is a block diagram showing the hardware structure of an interpolation processor 1 according to Embodiment 4. The interpolation processor 1 according to Embodiment 4 comprises a block length discriminating circuit 161, a selecting circuit 162, a first white noise storage 16L and a second white noise storage 16S in addition to the structure of Embodiments 1 and 2. The block length discriminating circuit 161 determines whether the block length of an inputted acoustic signal is a long block or a short block. The block length discriminating circuit 161 refers to a blocksplit_flag[ch] [gr] flag in a frame side information area in a bit stream and determines whether the block is a long block or a short block for each frame. It should be noted that one frame of a long block is composed of 576 samples of 18 samples×32 blocks and one frame of a short block is composed of 3 subblocks of 192 samples of 6 samples×32 blocks.

The block length discriminating circuit 161 outputs the discriminated block length to the selecting circuit 162 and the energy computing circuit 121. The energy computing circuit 121 divides the sum squared of coefficients I(m) by the number of samples so as to compute the energy of the coefficients I(m), when a mean power spectrum is to be computed as the energy. In order to provide said number of samples, the block length discriminating circuit 161 outputs the block length to the energy computing circuit 121. The energy computing circuit 121 suitably sets the number of samples to be used for division depending to the block length.

The selecting circuit 162 selects either the first white noise storage 16L or the second white noise storage 16S depending on the discriminated block length based on the block length discriminated by the block length discriminating circuit 161 and outputs selection information to the output circuit 14. In Embodiment 4, two types of white noise storages are provided. The first white noise storage 16L is the same as that shown in Embodiment (see FIG. 5) and is selected when the selecting circuit 162 determines that the block length is a long block. On the other hand, the second white noise storage 16S is selected when the selecting circuit 162 determines that the block length is a short block. It should be noted that two storages of a first white noise storage 16L and a second white noise storage 16S are provided corresponding to a long block and a short block in the present Embodiment 4 for ease of explanation. However, when there are three or more types of different block lengths, there or more types of white noise storages may be prepared depending on the block length.

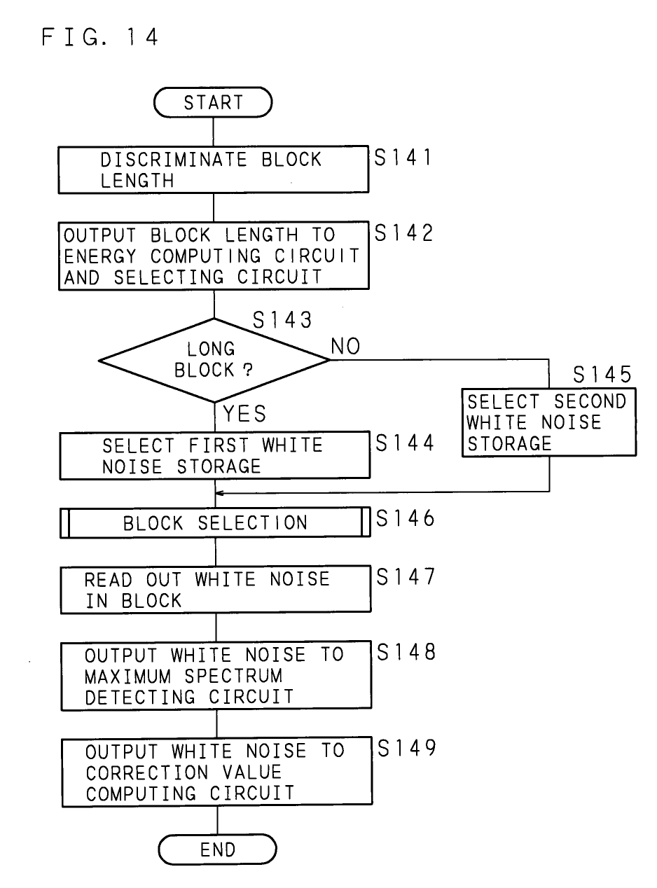

FIG. 13 is an explanatory view showing the record layout of the second white noise storage 16S. The second white noise storage 16S comprises a block field, a number m field and a spectrum Iwn(m) field. The number of blocks composing white noise corresponding to a short block is stored in the block field and 32 blocks in total from a block 0 to a block 31 are prepared. A number for distinguishing a spectrum of white noise for each block is stored in the number m field.

Moreover, spectrums of white noise corresponding to numbers m are respectively stored in the spectrum Iwn(m) field. In the present Embodiment 4, all 32 blocks of six spectrums for one block, or 192 spectrums in total, are stored. For example, a spectrum “0.007248” of white noise is stored for a number “1” of a block “0”. Similarly to a long block, the spectrum of white noise may be set so that the average of all the spectrums becomes a predetermined value, e.g., approximately −20 dB. It should be noted that said Iwn(m) is a table for creating white noise of a level of approximately half of the minimum value of I(m) and it is unnecessary to limit Iwn(m) to a numeric of approximately −20 dB.

When the selecting circuit 162 selects the first white noise storage 16L, that is, when the block length is a long block, the output circuit 14 outputs spectrums of a plurality of blocks, which are selected at random or regularly from the first white noise storage 16L shown in FIG. 5, to the maximum spectrum detecting circuit 15 and the correction value computing circuit 13 corresponding to a block in which there is a spectrum having null I(m). On the other hand, when the selecting circuit 162 selects the second white noise storage 16S, that is, when the block length is a short block, the output circuit 14 outputs spectrums of a plurality of blocks, which are selected at random or regularly from the second white noise storage 16S shown in FIG. 13, to the maximum spectrum detecting circuit 15 and the correction value computing circuit 13.

A correction value to be outputted to the correction frequency coefficient computing circuit 17 is computed by detecting the maximum value of spectrums belonging to a plurality of blocks of white noise selected as described above by the maximum spectrum detecting circuit 15, dividing the minimum value of the coefficient I(m) by the maximum value of the spectrum of white noise by the correction coefficient computing circuit 18 so as to compute the correction coefficient, and multiplying each spectrum of the block by said correction coefficient by the correction value computing circuit 13.

A plurality of blocks to be outputted from the output circuit 14 are selected by the output circuit 14 from the first white noise storage 16L or the second white noise storage 16S by selecting an arbitrary block at random with a random number generator which is not illustrated, for example. Instead, a block may be selected periodically so that all the blocks are selected evenly. For example, a block may be outputted so that all the blocks “0”-“31” in the first white noise storage 16L or the second white noise storage 16S are respectively selected once. As described above, by selecting a block of white noise at random or regularly, a correction value to be added to the coefficient I(m) is flattened without being biased to specific white noise and it becomes possible to realize a more natural interpolation process.

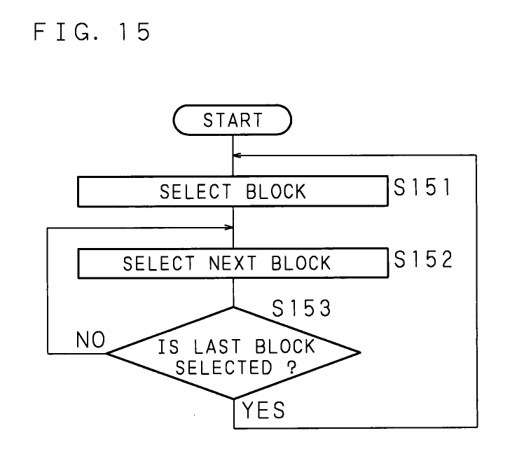

FIG. 14 is a flow chart showing the procedure of a selection process of the first white noise storage 16L or the second white noise storage 16S. The block length discriminating circuit 161 refers to frame side information of an inputted bit stream and determines whether the block length is a long block or a short block (step S141). The block length discriminating circuit 161 outputs the discriminated block length to the energy computing circuit 121 and the selecting circuit 162 (step S142). The selecting circuit 162 determines whether the block length discriminated by the block length discriminating circuit 161 is a long block or not (step S143). When determining that the block length is a long block (YES in the step S143), the selecting circuit 162 selects the first white noise storage 16L (step S144) and outputs a signal indicating that the block length is a long block to the output circuit 14.

On the other hand, when determining that the block length is not a long block (NO in the step S143), the selecting circuit 162 selects the second white noise storage 16S (step S145) and outputs a signal indicating that the block length is a short block to the output circuit 14. When the selecting circuit 162 selects the first white noise storage 16L, that is, when the block length is a long block, the output circuit 14 selects a plurality of block, which are selected at random or regularly, from the first white noise storage 16L shown in FIG. 5 (step S146). Similarly, when the selecting circuit 162 selects the second white noise storage 16S, that is, when the block length is a short block, the output circuit 14 selects a plurality of blocks, which are selected at random or regularly, from the second white noise storage 16S shown in FIG. 13 (step S146). It should be noted that this selection process procedure of blocks will be explained later.

The output circuit 14 reads out white noise of a plurality of blocks selected at random or regularly (step S147). The output circuit 14 then outputs the read-out white noise (spectrum) to the maximum spectrum detecting circuit 15 (step S148). The maximum spectrum detecting circuit 15 detects the maximum absolute value of spectrums of the outputted white noise. The output circuit 14 also outputs white noise of blocks selected at random or regularly to the correction value computing circuit 13 (step S149). Since the subsequent computation of a correction coefficient and computation of a correction value are explained in detail in Embodiments 1 and 2, explanation thereof will be omitted.

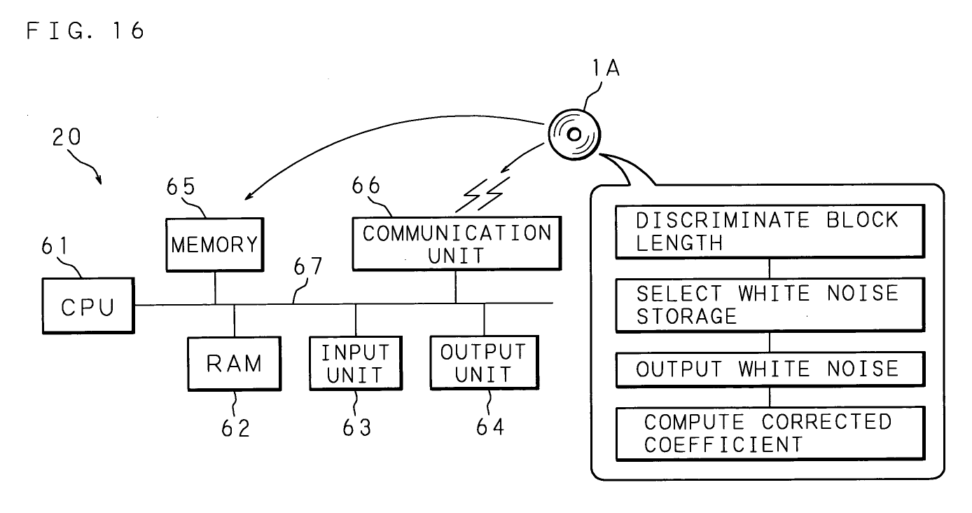

FIG. 15 is a flow chart showing the procedure of a selection process of a block. The following description will explain the procedure for selecting one block from the first white noise storage 16L or the second white noise storage 16S by the output circuit 14. It should be noted that the following description will explain a form wherein the block length is a long block and white noise according to one block is to be outputted from the first white noise storage 16L. The output circuit 14 first selects a block 0 of the first white noise storage 16L shown in FIG. 5 (step S151). The output circuit 14 then outputs 18 white noise belonging to the block 0 of the first white noise storage 16L to the maximum spectrum detecting circuit 15 and the correction value computing circuit 13.

The output circuit 14 then selects the next block (step S152). For example, a block 1 is selected after selecting the block 0.

The output circuit 14 reads out white noise in the next block from the first white noise storage 16L and outputs the white noise to the maximum spectrum detecting circuit 15 and the correction value computing circuit 13. The output circuit 14 determines whether the block selected in the step S152 is the last block (block 31 in the example of FIG. 5) or not (step S153). When determining that the selected block is not the last block (NO in the step S153), the output circuit 14 goes to the step S152 and further selects the next block.

On the other hand, when determining that the block selected in the step S152 is the last block (YES in the step S153), that is, when determining that a block 31 is selected in the above example, the output circuit 14 goes to the step S151 and selects a block 0 next. As described, since a block of white noise is selected regularly and white noise of all the 576 samples of one frame is selected evenly and outputted, a correction value is flattened without being biased to specific white noise and it becomes possible to realize a more natural interpolation process. For selecting a block at random, it should be noted that a block corresponding to a numeric generated by a random number generator, which is not illustrated, may be selected.

Since the present Embodiment 4 has such a structure and other structures and functions are the same as those of Embodiments 1 to 3, like codes are used to refer to like parts and detailed explanation thereof will be omitted.

### Embodiment 5

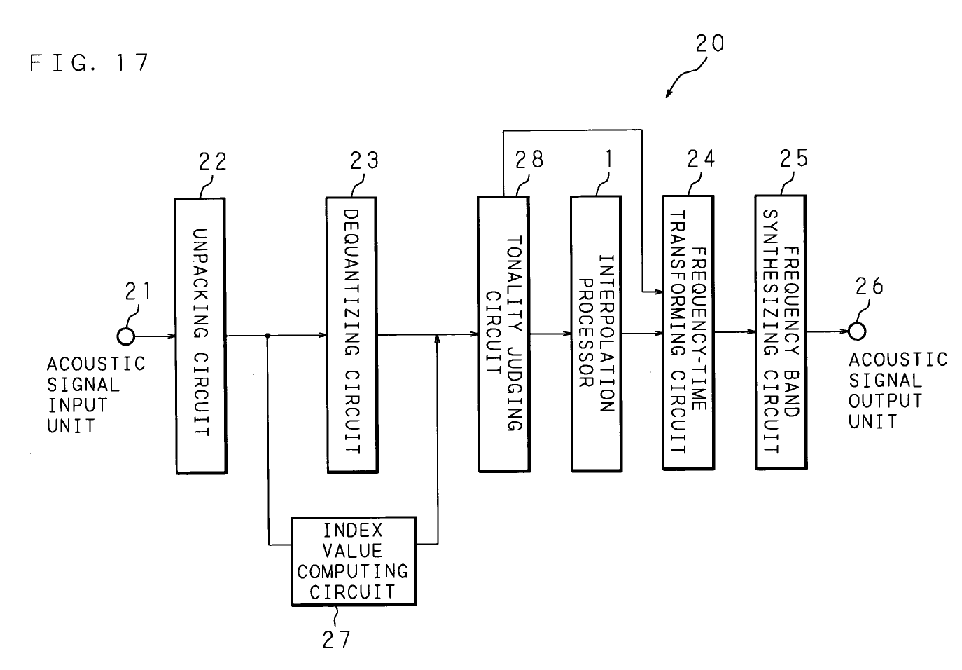

The process according to Embodiment 4 may be realized as a software process using a personal computer shown in FIG. 11. FIG. 16 is a block diagram showing the structure of a signal processing apparatus 20 according to Embodiment 5. A computer program for causing the personal computer 20, which is a signal processing apparatus, to operate can be provided in the form of a portable recording medium 1A such as a CD-ROM, an MO or a DVD-ROM as in the present Embodiment 5. Furthermore, it is also possible to download the computer program from a server computer, which is not illustrated, via the communication unit 66. The following description will explain the content thereof.

The portable recording medium 1A (CD-ROM, MO, DVD-ROM or the like) which records therein a computer program for causing a reader/writer, that is not illustrated, in the personal computer 20 shown in FIG. 16 to discriminate the block length, select a white noise storage, output white noise and compute a corrected coefficient is inserted to install said program into a control program in the memory 65. Instead, such a program may be downloaded from an external server computer, which is not illustrated, via the communication unit 66 and installed into the memory 65. Such a program is loaded into the RAM 62 for execution. In this manner, the personal computer functions as a signal processing apparatus 20 according to the present invention as described above.

Since the present Embodiment 5 has such a structure and other structures and functions are the same as those of Embodiments 1 to 4, like codes are used to refer to like parts and detailed explanation thereof will be omitted.

### Embodiment 6

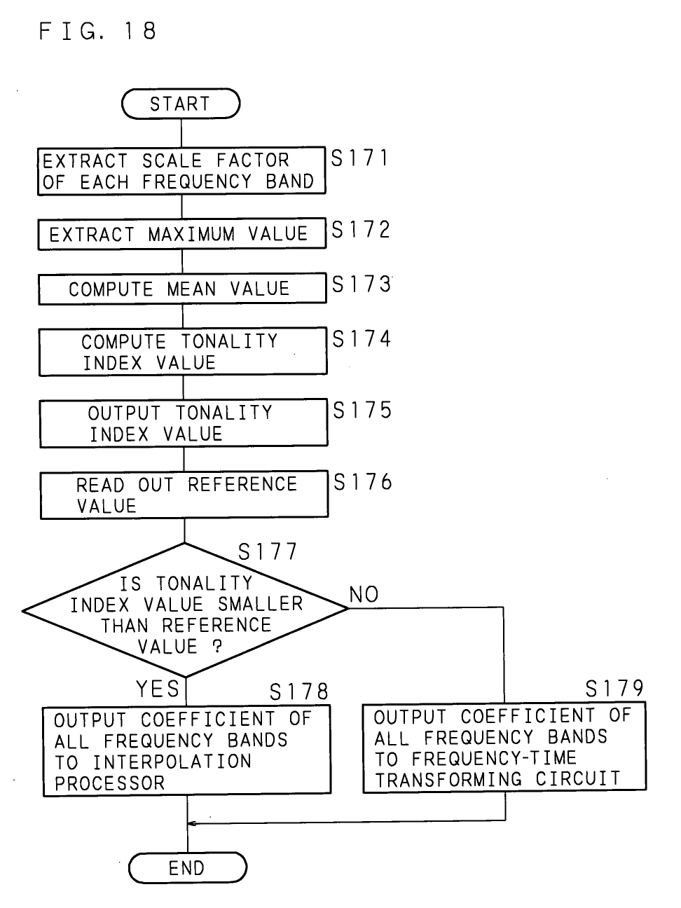

Embodiment 6 relates to a form for determining whether a coefficient is to be corrected or not depending on the tonality of an acoustic signal. FIG. 17 is a block diagram showing the hardware structure of a decoding apparatus 20 according to Embodiment 6. As shown in FIG. 17, an index value computing circuit 27 and a tonality judging circuit 28 are newly provided. The unpacking circuit 22 extracts a scale factor for each frequency band from frame side information of a bit stream.

The index value computing circuit 27 computes a tonality index value indicative of the degree of tonality by subtracting a mean value from the maximum value of a scale factor of each frequency band. The computed tonality index value is outputted to the tonality judging circuit 28. A reference value is stored in a memory, which is not illustrated, in the tonality judging circuit 28, and the tonality judging circuit 28 compares the inputted tonality index value with the reference value so as to determine whether the tone is a pure tone or not. It should be noted that said reference value may be 70 dB when the maximum value of the scale factor is 120 dB, for example.

When the tonality index value is smaller than the reference value, the tonality judging circuit 28 determines that the tonality is low and outputs coefficients I(m) of all the frequency bands to the interpolation processor 1 so as to perform the interpolation process descried above. On the other hand, when the tonality index value is larger than the reference value, the tonality judging circuit 28 determines that the tonality is high and outputs the coefficients I(m) of all the frequency bands directly to the frequency-time transforming circuit 24 without outputting the same to the interpolation processor 1. By executing or not executing an interpolation process depending on the characteristic of an acoustic signal as described above, a suitable interpolation process becomes possible and it becomes possible to speed up processing and reduce the power consumption.

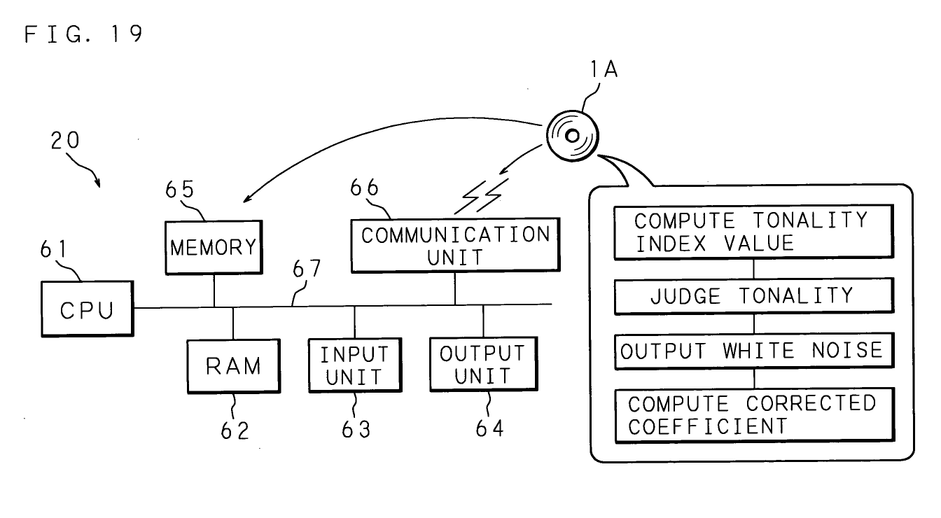

FIG. 18 is a flow chart showing the procedure of a tonality judging process. First, the unpacking circuit 22 extracts a scale factor of each frequency band from frame side information of a bit stream (step S171). The extracted scale factor is outputted to the index value computing circuit 27. The index value computing circuit 27 extracts the maximum value from a scale factor of each frequency band (step S172). The index value computing circuit 27 also computes the mean value of the scale factor (step S173). The index value computing circuit 27 subtracts the mean value from the maximum value of the scale factor so as to compute a tonality index value (step S174). The index value computing circuit 27 outputs the computed tonality index value to the tonality judging circuit 28 (step S175).

The tonality judging circuit 28 reads out a reference value from a memory, which is not illustrated, provided therein (step S176). The tonality judging circuit 28 then compares the inputted tonality index value with the reference value and determines whether the tonality index value is smaller than the read-out reference value or not (step S177). When determining that the tonality index value is smaller than the reference value (YES in the step S177), the tonality judging circuit 28 determines that the tonality is low and outputs the coefficients I(m) of all the frequency bands to the interpolation processor 1 (step S178).

On the other hand, when determining that the tonality index value is larger than the reference value (NO in the step S177), the tonality judging circuit 28 determines that the tonality is high and outputs the coefficients I(m) of all the frequency bands directly to the frequency-time transforming circuit 24 without outputting the same to the interpolation processor 1 (step S179). It should be noted that whether the tone is a pure tone or not may be determined based on power of each frequency band, though whether the tone is a pure tone or not is determined in the present Embodiment 6 based on the scale factor. In this case, the index value computing circuit 27 subtracts the mean value from the maximum value of power of coefficients I(m) of each frequency band and outputs the result as a tonality index value to the tonality judging circuit 28. In the tonality judging circuit 28, 40 dB is stored as the reference value, for example. When the tonality index value is smaller than said reference value, the tonality judging circuit 28 determines that the tonality is low and outputs the coefficients I(m) of all the frequency bands to the interpolation processor 1. On the other hand, when the tonality index value is larger than the reference value, the tonality judging circuit 28 determines that the tonality is high and outputs the coefficients I(m) of all the frequency bands to the frequency-time transforming circuit 24 without going through the interpolation processor 1. It should be noted that a technique disclosed in Japanese Patent Application Laid-Open No. 2002-351500 or Japanese Patent Application Laid-Open No. 2005-195983 may be applied to the determination of tonality described above.

Since the present Embodiment 6 has such a structure and other structures and functions are the same as those of Embodiments 1 to 5, like codes are used to refer to like parts and detailed explanation thereof will be omitted.

### Embodiment 7

The process according to Embodiment 6 may be realized as a software process using a personal computer shown in FIG. 11. FIG. 19 is a block diagram showing the structure of a signal processing apparatus 20 according to Embodiment 7. A computer program for causing the personal computer 20, which is a signal processing apparatus, to operate can be provided in the form of a portable recording medium 1A such as a CD-ROM, an MO or a DVD-ROM as in the present Embodiment 7. Furthermore, it is also possible to download the computer program from a server computer, which is not illustrated, via the communication unit 66. The following description will explain the content thereof.

The portable recording medium 1A (CD-ROM, MO, DVD-ROM or the like), which records therein a computer program for causing a reader/writer, that is not illustrated, in the personal computer 20 shown in FIG. 19 to compute a tonality index value, determine whether the tonality is high or not, output white noise and compute a corrected coefficient depending on whether the tonality is high or not, is inserted to install said program into a control program in the memory 65. Instead, such a program may be downloaded from an external server computer, which is not illustrated, via the communication unit 66 and installed into the memory 65. Such a program is loaded into the RAM 62 for execution. In this manner, the personal computer functions as a signal processing apparatus 20 according to the present invention as described above.

Since the present Embodiment 7 has such a structure and other structures and functions are the same as those of Embodiments 1 to 6, like codes are used to refer to like parts and detailed explanation thereof will be omitted.

### Embodiment 8

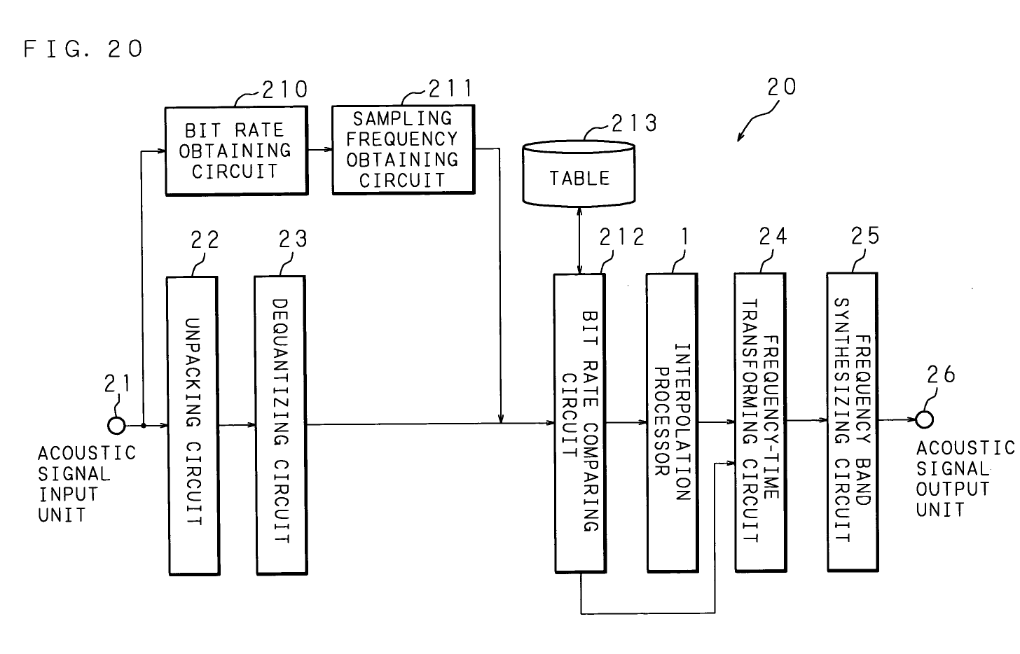

Embodiment 8 relates to a form for determining whether an interpolation process is to be executed or not depending on a bit rate. FIG. 20 is a block diagram showing the hardware structure of a decoding apparatus 20 according to Embodiment 8. As shown in FIG. 20, a bit rate obtaining circuit 210, a sampling frequency obtaining circuit 211, a bit rate comparing circuit 212 and a table 213 are newly provided. The bit rate obtaining circuit 210 obtains a bit rate of an acoustic signal from a bit rate index described in a header attached to an acoustic signal. The obtained bit rate is outputted to the bit rate comparing circuit 212 via the sampling frequency obtaining circuit 211.

The sampling frequency obtaining circuit 211 obtains a sampling frequency described in a header attached to an acoustic signal. In MP3 method, any one of 32 kHz, 44.1 kHz and 48 kHz is obtained as a sampling frequency. The sampling frequency obtaining circuit 211 outputs the obtained sampling frequency to the bit rate comparing circuit 212.

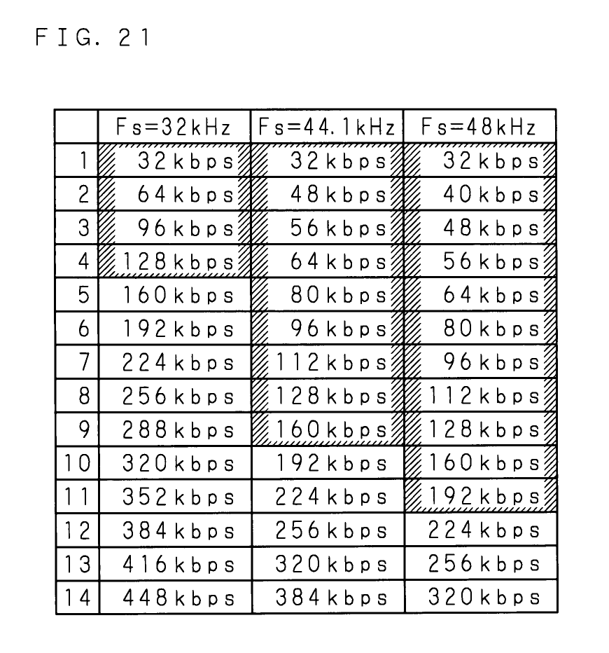

FIG. 21 is an explanatory view showing the record layout of the table 213. Stored in the table 213 is a reference bit rate which is a reference for each sampling frequency. In the table 213, a bit rate is stored for each of sampling frequencies of 32 kHz, 44.1 kHz and 48 kHz. For 32 kHz, 160 kbps is stored as the reference bit rate so that determination of tonality and an interpolation process described above are performed when the bit rate is smaller than 160 kbps as shown in FIG. 21 by hatching.

Moreover, for 44.1 kHz, 192 kbps is stored as the reference bit rate so that determination of tonality and an interpolation process described above are performed when the bit rate is smaller than 192 kbps as shown in FIG. 21 by hatching. Furthermore, for 48 kHz, 224 kbps is stored as the reference bit rate so that determination of tonality and an interpolation process described above are performed when the bit rate is smaller than 224 kbps as shown in FIG. 21 by hatching. It should be noted that the sampling frequency for a minidisk of ATRAC3 specification is only 44.1 kHz and the reference bit rate is 292 kbps in this case so that determination of tonality and an interpolation process described above are performed when the bit rate is 132 kbps, 105 kbps or 66 kbps, which is smaller than 292 kbps.

The bit rate comparing circuit 212 reads out a reference bit rate from the table 213 based on the sampling frequency outputted from the sampling frequency obtaining circuit 211. The bit rate comparing circuit 212 then determines whether the bit rate outputted from the bit rate obtaining circuit 210 is smaller than the reference bit rate or not. When determining that the bit rate outputted from the bit rate obtaining circuit 210 is smaller than the reference bit rate, the bit rate comparing circuit 212 outputs coefficients I(m) of all the frequency bands to the interpolation processor 1. For example, when the obtained sampling frequency is 32 kHz and the obtained bit rate is 32 kbps, 64 kbps, 96 kbps or 128 kbps, the coefficients I(m) of all the frequency bands become subject to an interpolation process.

On the other hand, when determining that the bit rate outputted from the bit rate obtaining circuit 210 is not smaller than the reference bit rate, the bit rate comparing circuit 212 outputs coefficients I(m) of each frequency band directly to the frequency-time transforming circuit 24 without going through the interpolation processor 1. For example, when the obtained sampling frequency is 32 kHz and the obtained bit rate is 160 kbps, 192 kbps, 224 kbps, 256 kbps, 288 kbps, 320 kbps, 352 kbps, 384 kbps, 416 kbps or 448 kbps, coefficients I(m) of each frequency band do not become subject to an interpolation process. Since an interpolation process is executed or not executed depending on the sampling frequency and the bit rate as described above, the most suitable interpolation process matching the state of the acoustic signal becomes possible and it becomes possible to speed up processing and reduce the power consumption.

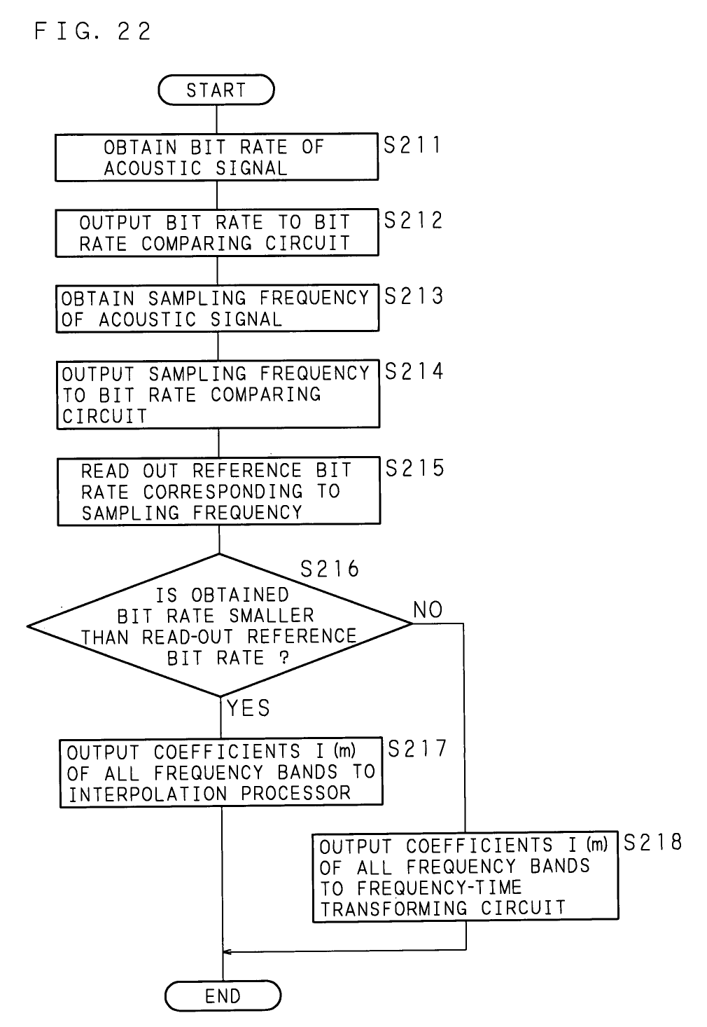

FIG. 22 is a flow chart showing the procedure of a comparison process. The bit rate obtaining circuit 210 obtains a bit rate of an acoustic signal from a bit rate index described in a header attached to an acoustic signal (step S211). The bit rate obtaining circuit 210 outputs the obtained bit rate to the bit rate comparing circuit 212 via the sampling frequency obtaining circuit 211 (step S212). The sampling frequency obtaining circuit 211 obtains a sampling frequency described in a header attached to an acoustic signal (step S213). The sampling frequency obtaining circuit 211 outputs the obtained sampling frequency to the bit rate comparing circuit 212 (step S214).

The bit rate comparing circuit 212 reads out, from the table 213, a reference bit rate corresponding to the sampling frequency outputted from the sampling frequency obtaining circuit 211 (step S215). The bit rate comparing circuit 212 then determines whether the bit rate obtained by the bit rate obtaining circuit 210 is smaller than the read-out reference bit rate or not (step S216). When determining that the obtained bit rate is smaller than the reference bit rate (YES in the step S216), the bit rate obtaining circuit 210 outputs coefficients I(m) of all the frequency bands to the interpolation processor 1 (step S217).

On the other hand, when determining that the obtained bit rate is not smaller than the reference bit rate (NO in the step S216), the bit rate obtaining circuit 210 outputs coefficients I(m) of all the frequency bands directly to the frequency-time transforming circuit 24 without going through the interpolation processor 1 (step S218).

Since the present Embodiment 8 has such a structure and other structures and functions are the same as those of Embodiments 1 to 7, like codes are used to refer to like parts and detailed explanation thereof will be omitted.

### Embodiment 9

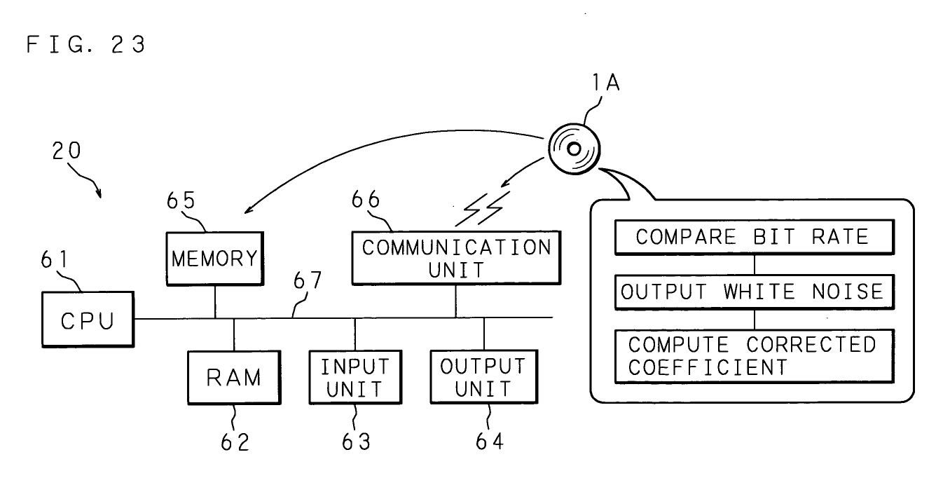

The process according to Embodiment 8 may be realized as a software process using the personal computer shown in FIG. 11. FIG. 23 is a block diagram showing the structure of a signal processing apparatus 20 according to Embodiment 9. A computer program for causing the personal computer 20, which is a signal processing apparatus, to operate can be provided in the form of a portable recording medium 1A such as a CD-ROM, an MO or a DVD-ROM as in the present Embodiment 9. Furthermore, it is also possible to download the computer program from a server computer, which is not illustrated, via the communication unit 66. The following description will explain the content thereof.

The portable recording medium 1A (CD-ROM, MO, DVD-ROM or the like) which records therein a computer program for causing a reader/writer, that is not illustrated, in the personal computer 20 shown in FIG. 23 to compare bit rates, output white noise and compute a corrected coefficient depending on the bit rate is inserted to install said program into a control program in the memory 65. Instead, such a program may be downloaded from an external server computer, which is not illustrated, via the communication unit 66 and installed into the memory 65. Such a program is loaded into the RAM 62 for execution. In this manner, the personal computer functions as a signal processing apparatus 20 according to the present invention as described above.

Since the present Embodiment 9 has such a structure and other structures and functions are the same as those of Embodiments 1 to 8, like codes are used to refer to like parts and detailed explanation thereof will be omitted.

### Embodiment 10

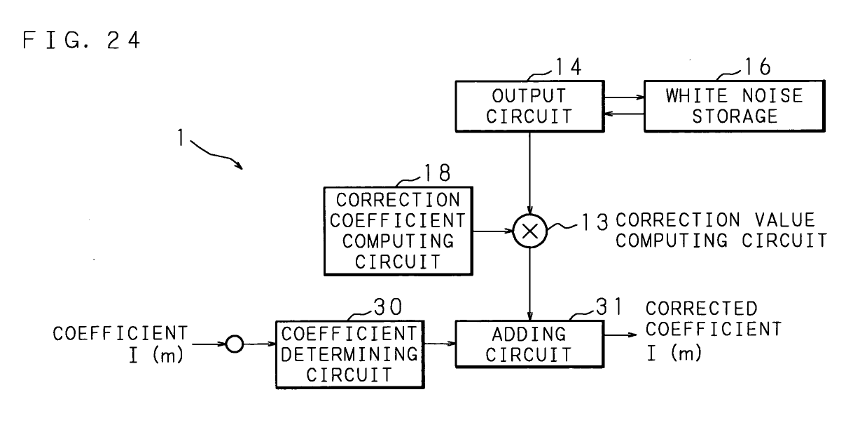

Embodiment 10 relates to a form for determining whether there is a null orthogonal transform coefficient in a frequency band of a coded acoustic signal or a coded image signal or not and adding an orthogonal transform coefficient according to a white noise source to said frequency band when there is a null orthogonal transform coefficient. FIG. 24 is a block diagram showing the hardware structure of an interpolation processor 1 according to Embodiment 10. A decoding apparatus 20 comprising the interpolation processor 1 in the figure dequantizes and processes a coded acoustic signal or a coded image signal obtained by coding an acoustic signal or an image signal which is obtained by orthogonal transform for each frame unit at a predetermined time. The present embodiment will be explained using a form for processing a coded acoustic signal, using an example wherein MDCT is used as the orthogonal transform method. However, the present invention is not limited to this and a coded image signal may be used, or DCT, FFT (Fast Fourier Transform) or the like may be used as the orthogonal transform method.

The interpolation processor 1 according to Embodiment 10 comprises a coefficient determining circuit 30, an adding circuit 31, a correction coefficient computing circuit 18, a correction value computing circuit 13, an output circuit 14 and a white noise storage 16. It should be noted that the correction coefficient computing circuit 18, the correction value computing circuit 13, the output circuit 14 and the white noise storage 16 are the same as those described in Embodiments 1 to 9 and detailed explanation thereof will be omitted. The dequantized coefficients I(m) are inputted into the coefficient determining circuit 30. The coefficient determining circuit 30 determines whether there is a coefficient I(m) having a null spectrum (orthogonal transform coefficient) or not for each frequency band.

When determining that there is a coefficient I(m) having a null spectrum in a frequency band, the coefficient determining circuit 30 sets a flag in said frequency band and outputs the coefficients I(m) to the adding circuit 31. On the other hand, when determining that there is not a coefficient I(m) having a null spectrum in a frequency band, the coefficient determining circuit 30 outputs the coefficients I(m) to the adding circuit 31 without setting a flag in said frequency band. The white noise storage 16 which is a white noise source is composed of orthogonal transform coefficients (spectrums of white noise) obtained by dividing white noise at a time corresponding to the above frame into a plurality of bands (blocks) and applying orthogonal transform for each band. It should be noted that the present invention will be explained using an example applied to white noise according to a long block shown in FIG. 5.

The output circuit 14 reads out, from the white noise storage 16, a predetermined band, that is, a spectrum (orthogonal transform frequency) of white noise according to a block selected at random or regularly, as described in Embodiment 4 and outputs the read-out spectrum of white noise to the correction value computing circuit 13. On the other hand, the correction coefficient computing circuit 18 described in Embodiments 1 and 2 outputs a computed correction coefficient to the correction value computing circuit 13. The correction value computing circuit 13 computes a correction value by multiplying a spectrum of white noise according to the block outputted from the output circuit 14 by the outputted correction coefficient. The correction value computing circuit 13 outputs the computed correction value to the adding circuit 31. The adding circuit 31 adds the correction value outputted from the correction value computing circuit 13, that is, a value relating to an orthogonal transform coefficient according to a predetermined band read out from a white noise source to a coefficient I(m) according to a frequency band in which a flag is set among the coefficient I(m) according to a frequency band outputted from the coefficient determining circuit 30. It should be noted that a spectrum of white noise may be added only for a coefficient I(m) having a null spectrum. It should be noted that, though the present invention is constructed to perform computation of multiplying, by the correction value computing circuit 13, a spectrum of white noise of a predetermined band stored in the white noise storage 16 by the correction value computed by the correction coefficient computing circuit 18, the spectrum of white noise of a predetermined band may be outputted directly to the adding circuit 31 without performing said multiplication process.

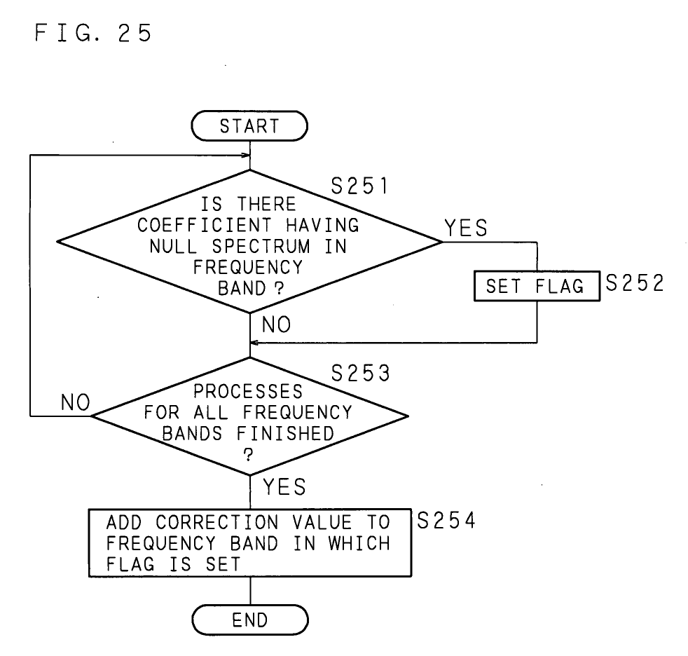

FIG. 25 is a flow chart showing the procedure of an adding process of white noise. The coefficient determining circuit 30 determines whether there is a coefficient of a null spectrum in a frequency band or not (step S251). When determining that there is at least one coefficient of a null spectrum (YES in the step S251), the coefficient determining circuit 30 sets a flag in said frequency band (step S252). It should be noted that, though the above technique is constructed to set a flag in the step S251 when there is at least one coefficient having a null spectrum, a flag may be set when there is a predetermined number of coefficients having a null spectrum. On the other hand, determining that there is not a coefficient having a null spectrum in the frequency band (NO in the step S251), the coefficient determining circuit 30 skips the process of the step S252. The coefficient determining circuit 30 then determines whether the process of the step S251 has been performed for all the frequency bands or not (step S253).

When determining that the process has not been performed for all the frequency bands (NO in the step S253), the coefficient determining circuit 30 goes to the step S251 and repeatedly executes the above process. On the other hand, when determining that the process for all the frequency bands has been finished (YES in the step S253), the coefficient determining circuit 30 outputs, to the adding circuit 31, information indicative of the presence or absence of flag setting and coefficients in each frequency band. The output circuit 14 reads out, from the white noise storage 16, a spectrum of white noise according to a block selected at random or regularly as described in Embodiment 4 and outputs the read-out spectrum of white noise to the correction value computing circuit 13. The correction coefficient computing circuit 18 outputs a computed correction coefficient to the correction value computing circuit 13. The correction value computing circuit 13 computes a correction value by multiplying a spectrum of white noise according to the block outputted from the output circuit 14 by the outputted correction coefficient. The correction value computing circuit 13 outputs the computed correction value to the adding circuit 31. The adding circuit 31 adds the correction value read out from the white noise storage 16 to the frequency band in which a flag is set (step S254). The adding circuit 31 similarly adds the correction value based on the spectrum of white noise according to a block selected at random or regularly to coefficients of other frequency bands in which a flag is set. The adding circuit 31 outputs, to the frequency-time transforming circuit 24, the coefficient of the frequency band after the addition and outputs, to the frequency-time transforming circuit 24, coefficients according to frequency bands in which a flag is not set without adding the correction value based on the spectrum of white noise.

Since the present Embodiment 10 has such a structure and other structures and functions are the same as those of Embodiments 1 to 9, like codes are used to refer to like parts and detailed explanation thereof will be omitted.

### Embodiment 11

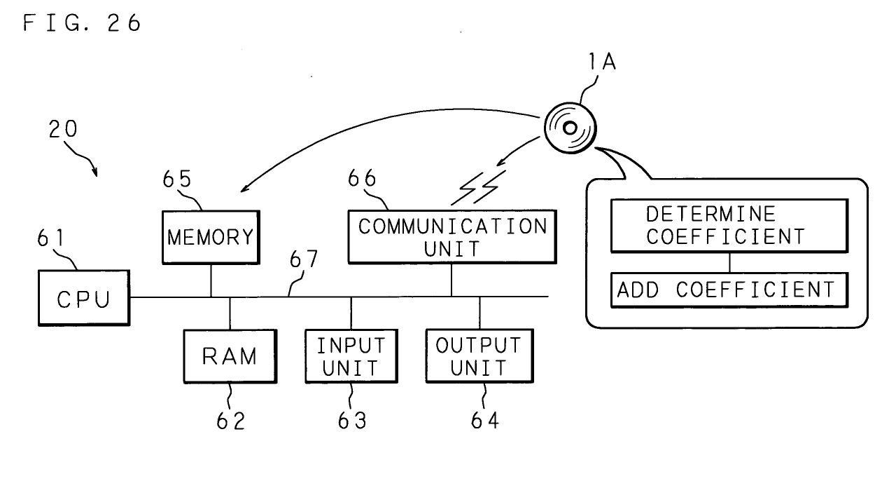

The process according to Embodiment 10 may be realized as a software process using the personal computer shown in FIG. 11. FIG. 26 is a block diagram showing the structure of a signal processing apparatus 20 according to Embodiment 11. A computer program for causing the personal computer 20, which is a signal processing apparatus, to operate can be provided in the form of a portable recording medium 1A such as a CD-ROM, an MO or a DVD-ROM as in the present Embodiment 11. Furthermore, it is also possible to download the computer program from a server computer, which is not illustrated, via the communication unit 66. The following description will explain the content thereof.

The portable recording medium 1A (CD-ROM, MO, DVD-ROM or the like) which records therein a computer program for causing a reader/writer, that is not illustrated, in the personal computer 20 shown in FIG. 26 to determine whether there is a coefficient described above or not and add a coefficient is inserted to install said program into a control program in the memory 65. Instead, such a program may be downloaded from an external server computer, which is not illustrated, via the communication unit 66 and installed into the memory 65. Such a program is loaded into the RAM 62 for execution. In this manner, the personal computer functions as a signal processing apparatus 20 according to the present invention as described above.

Since the present Embodiment 11 has such a structure and other structures and functions are the same as those of Embodiments 1 to 10, like codes are used to refer to like parts and detailed explanation thereof will be omitted.

As this invention may be embodied in several forms without departing from the spirit of essential characteristics thereof, present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A signal processing method for processing an acoustic signal obtained by dequantizing a coded acoustic signal, comprising:
a level detecting step of detecting a level of a coefficient of a dequantized acoustic signal;
a correction coefficient computing step of computing a correction coefficient based on the level and white noise outputted from a white noise storage which stores white noise;
a correction value computing step of computing a correction value by multiplying white noise stored in the white noise storage by the correction coefficient; and
a correction frequency coefficient computing step of computing a corrected coefficient by adding the correction value to a coefficient of a dequantized acoustic signal.

2. A signal processing apparatus for processing an acoustic signal obtained by dequantizing a coded acoustic signal, comprising:
a level detecting circuit for detecting a level of a coefficient of a dequantized acoustic signal;
a correction coefficient computing circuit for computing a correction coefficient based on the level and white noise outputted from a white noise storage which stores white noise;
a correction value computing circuit for computing a correction value by multiplying white noise stored in the white noise storage by the correction coefficient; and
a correction frequency coefficient computing circuit for computing a corrected coefficient by adding the correction value to a coefficient of a dequantized acoustic signal.

3. The signal processing apparatus according to claim 2, wherein the level detecting circuit is constructed to detect a minimum value, excluding zero, of a coefficient of the quantized acoustic signal.

4. The signal processing apparatus according to claim 2, wherein the correction coefficient computing circuit is constructed to compute a correction coefficient by dividing a level detected by the level detecting circuit by a level of white noise stored in the white noise storage.

5. The signal processing apparatus according to claim 4, wherein the level of the white noise is a maximum value or a mean value of white noise stored in the white noise storage.

6. The signal processing apparatus according to claim 2, further comprising:
an energy computing circuit for computing energy or a mean power spectrum based on a coefficient of a dequantized acoustic signal;
an energy change rate computing circuit for computing a rate of change between energy or a mean power spectrum of a unit of decoding processing at a predetermined time computed by the energy computing circuit and energy or a mean power spectrum of a unit of decoding processing before the predetermined time;
a level change rate computing circuit for computing a rate of change between a level of a unit of decoding processing at a predetermined time detected by the level detecting circuit and a level of a unit of decoding processing before the predetermined time;
a determining circuit for determining whether the energy change rate is larger than the level change rate or not;
a level correcting circuit for correcting a level to be used by the correction coefficient computing circuit when it is determined by the determining circuit that the energy change rate is smaller than the level change rate; and
a correction level setting circuit for setting a level corrected by the level correcting circuit to a level to be used by the level change rate computing circuit.

7. The signal processing apparatus according to claim 6, wherein the level correcting circuit is constructed to correct a level to be used by the correction coefficient computing circuit so that the rate of change of the energy or the mean power spectrum and the level change rate become approximately equal.

8. The signal processing apparatus according to claim 6, wherein the correction coefficient computing circuit is constructed to compute a correction coefficient based on white noise and a level detected by the level detecting circuit when it is determined by the determining circuit that the energy change rate is larger than the level change rate.

9. The signal processing apparatus according to claim 6, further comprising a level setting circuit for setting a level detected by the level detecting circuit to a level to be used by the level change rate computing circuit when it is determined by the determining circuit that the energy change rate is larger than the level change rate.

10. A computer-readable recording medium which records therein a program for causing a computer to process an acoustic signal obtained by dequantizing a coded acoustic signal, comprising:
a level detecting step of detecting a level, excluding zero, of a coefficient of a dequantized acoustic signal;
a correction coefficient computing step of computing a correction coefficient based on the level and white noise outputted from a white noise storage which stores white noise;
a correction value computing step of computing a correction value by multiplying white noise stored in the white noise storage by the correction coefficient; and
a correction frequency coefficient computing step of computing a corrected coefficient by adding the correction value to a coefficient of a dequantized acoustic signal.

11. A signal processing method for processing an acoustic signal obtained by dequantizing a coded acoustic signal, comprising:
an index value computing step of computing a tonality index value indicative of a degree of tonality of a dequantized acoustic signal;
a tonality judging step of determining whether the acoustic signal is a pure tone or not by comparing the tonality index value computed in the index value computing step with a prestored reference value;
an output step of outputting white noise from a white noise storage which stores white noise; and
a correction frequency coefficient computing step of computing a corrected coefficient by adding a value relating to white noise outputted in the output step to each coefficient of the acoustic signal when it is not determined in the tonality judging step that the acoustic signal is a pure tone.

12. A signal processing method for processing an acoustic signal obtained by dequantizing a coded acoustic signal, comprising:
a bit rate comparing step of determining whether a bit rate of an acoustic signal is smaller than a prestored reference bit rate or not;
an output step of outputting white noise from a white noise storage which stores white noise; and
a correction frequency coefficient computing step of computing a corrected coefficient by adding a value relating to white noise outputted in the output step to each coefficient of the acoustic signal when it is determined in the bit rate comparing step that the bit rate of the acoustic signal is smaller than the reference bit rate.

13. A signal processing apparatus for processing an acoustic signal obtained by dequantizing a coded acoustic signal, comprising:
an index value computing circuit for computing a tonality index value indicative of a degree of tonality of a dequantized acoustic signal;
a tonality judging circuit for determining whether the acoustic signal is a pure tone or not by comparing the tonality index value computed by the index value computing circuit with a prestored reference value;
an output circuit for outputting white noise from a white noise storage which stores white noise; and
a correction frequency coefficient computing circuit for computing a corrected coefficient by adding a value relating to the white noise outputted from the output circuit to each coefficient of the acoustic signal when it is not determined by the tonality judging circuit that the acoustic signal is a pure tone.

14. The signal processing apparatus according to claim 13, wherein the index value computing circuit is constructed to make a value, which is obtained by subtracting a mean value from a maximum value of a value relating to a scale factor of each frequency band, a tonality index value.

15. A signal processing apparatus for processing an acoustic signal obtained by dequantizing a coded acoustic signal, comprising:
a bit rate comparing circuit for determining whether a bit rate of an acoustic signal is smaller than a prestored reference bit rate or not;
an output circuit for outputting white noise from a white noise storage which stores white noise; and
a correction frequency coefficient computing circuit for computing a corrected coefficient by adding a value relating to the white noise outputted from the output circuit to each coefficient of the acoustic signal when it is determined by the bit rate comparing circuit that the bit rate of the acoustic signal is smaller than the reference bit rate.

16. The signal processing apparatus according to claim 15, further comprising a table which stores a reference bit rate to be a reference for each sampling frequency,
wherein the bit rate comparing circuit is constructed to read out a reference bit rate corresponding to a sampling frequency of an acoustic signal from the table and determine whether the bit rate of the acoustic signal is smaller than the read-out reference bit rate or not, and
the correction frequency coefficient computing circuit is constructed to compute a corrected coefficient by adding a value relating to the white noise outputted from the output circuit to a coefficient of each frequency band of the acoustic signal when it is determined by the bit rate comparing circuit that the bit rate of the acoustic signal is smaller than the reference bit rate.

17. The signal processing apparatus according to claim 13, further comprising:
a level detecting circuit for detecting a level of a coefficient of a dequantized acoustic signal;
a correction coefficient computing circuit for computing a correction coefficient based on the level and white noise outputted from the white noise storage; and
a correction value computing circuit for computing a correction value by multiplying white noise stored in the white noise storage by the correction coefficient,
wherein the correction frequency coefficient computing circuit is constructed to compute a corrected coefficient by adding the correction value, as a value relating to white noise, to a coefficient of a dequantized acoustic signal.

18. The signal processing apparatus according to claim 17, wherein the level detecting circuit is constructed to detect a minimum value, excluding zero, of a coefficient of the dequantized acoustic signal.

19. The signal processing apparatus according to claim 17, wherein the correction coefficient computing circuit is constructed to compute a correction coefficient by dividing a level detected by the level detecting circuit by a level of white noise stored in the white noise storage.

20. The signal processing apparatus according to claim 19, wherein the level of the white noise is a maximum value or a mean value of white noise stored in the white noise storage.

21. A computer-readable recording medium which records therein a program for causing a computer to process an acoustic signal obtained by dequantizing a coded acoustic signal, comprising:
an index value computing step of computing a tonality index value indicative of a degree of tonality of a dequantized acoustic signal;
a tonality judging step of determining whether the acoustic signal is a pure tone or not by comparing the tonality index value computed in the index value computing step with a prestored reference value;
an output step of outputting white noise from a white noise storage which stores white noise; and
a correction frequency coefficient computing step of computing a corrected coefficient by adding a value relating to white noise outputted in the output step to each coefficient of the acoustic signal when it is not determined in the tonality judging step that the acoustic signal is a pure tone.

22. A computer-readable recording medium which records therein a program for causing a computer to process an acoustic signal obtained by dequantizing a coded acoustic signal, comprising:
a bit rate comparing step of determining whether a bit rate of an acoustic signal is smaller than a prestored reference bit rate or not;
an output step of outputting white noise from a white noise storage which stores white noise; and
a correction frequency coefficient computing step of computing a corrected coefficient by adding a value relating to white noise outputted in the output step to each coefficient of the acoustic signal when it is determined in the bit rate comparing step that the bit rate of the acoustic signal is smaller than the reference bit rate.

23. A signal processing method for dequantizing and processing a coded acoustic signal or a coded image signal obtained by coding an acoustic signal or an image signal which has undergone orthogonal transform for each frame unit at a predetermined time, comprising:
a coefficient determining step of determining whether there is a null orthogonal transform coefficient in a coded acoustic signal or a coded image signal which has been dequantized, for each frequency band according to the orthogonal transform coefficient; and
an adding step of adding an orthogonal transform coefficient according to a white noise source to a frequency band when it is determined in the coefficient determining step that there is a null orthogonal transform coefficient in the frequency band.

24. A signal processing apparatus for dequantizing and processing a coded acoustic signal or a coded image signal obtained by coding an acoustic signal or an image signal which has undergone orthogonal transform for each frame unit at a predetermined time, comprising:
a coefficient determining circuit for determining whether there is a null orthogonal transform coefficient in a coded acoustic signal or a coded image signal which has been dequantized, for each frequency band according to the orthogonal transform coefficient; and
an adding circuit for adding an orthogonal transform coefficient according to a white noise source to a frequency band when it is determined by the coefficient determining circuit that there is a null orthogonal transform coefficient in the frequency band.

25. The signal processing apparatus according to claim 24, wherein the white noise source is constituted of orthogonal transform coefficients obtained by dividing white noise at a time corresponding to the frame into a plurality of bands and applying orthogonal transform for each band.

26. The signal processing apparatus according to claim 25, wherein the adding circuit is constructed to add an orthogonal transform coefficient according to a predetermined band read out from a white noise source to a frequency band when it is determined by the coefficient determining circuit that there is a null orthogonal transform coefficient in the frequency band.

27. A computer-readable recording medium, which records therein a program for causing a computer to dequantize and process a coded acoustic signal or a coded image signal obtained by coding an acoustic signal or an image signal that has undergone orthogonal transform for each frame unit at a predetermined time, comprising:
a coefficient determining step of determining whether there is a null orthogonal transform coefficient in a coded acoustic signal or a coded image signal which has been dequantized, for each frequency band according to the orthogonal transform coefficient; and
an adding step of adding an orthogonal transform coefficient according to a white noise source to a frequency band when it is determined in the coefficient determining step that there is a null orthogonal transform coefficient in the frequency band.
